(19) United States
(12) Patent Application Publication
(10) Pub. No.: US 2005/0106470 A1
(43) Pub. Date: May 19, 2005

(54) Battery having electrolyte including one or more additives

(76) Inventors: Sang Young Yoon, Saugus, CA (US); Hiroshi Nakahara, Santa Clarita, CA (US); Khalil Amine, Downers Grove, IL (US)

Correspondence Address: ATTN: Travis Dodd;QUALLION LLC, P.O. Box 923127, Sylmar, CA, 91392-3192, US

(21) Appl. No.: 10/962,125

(22) Filed: Oct. 7, 2004

Related U.S. Application Data
(63) Continuation-in-part of application No. 10/496,231, filed on May 20, 2004.
(63) Continuation-in-part of application No. 10/810,019, filed on Mar. 25, 2004.
(63) Continuation-in-part of application No. 10/810,081, filed on Mar. 25, 2004.
(63) Continuation-in-part of application No. 10/810,080, filed on Mar. 25, 2004.
(60) Provisional application No. 60/451,065, filed on Feb. 26, 2003.
(60) Provisional application No. 60/542,017, filed on Feb. 4, 2004.
(60) Provisional application No. 60/543,951, filed on Feb. 11, 2004.
(60) Provisional application No. 60/543,898, filed on Feb. 11, 2004.
(60) Provisional application No. 60/601,452, filed on Aug. 13, 2004.
(60) Provisional application No. 60/563,850, filed on Apr. 19, 2004.
(60) Provisional application No. 60/565,211, filed on Apr. 22, 2004.
(60) Provisional application No. 60/563,848, filed on Apr. 19, 2004.
(60) Provisional application No. 60/563,849, filed on Apr. 19, 2004.
(60) Provisional application No. 60/563,852, filed on Apr. 19, 2004.

(30) Foreign Application Priority Data
Jan. 22, 2003 (WO) PCT/US03/02128
Jan. 22, 2003 (WO) PCT/US03/02127

(51) Int. Cl. H01M 10/40; H01M 2/16

(52) U.S. Cl. 429/324; 429/137; 429/328; 429/330

(57) ABSTRACT

A battery is disclosed. The battery includes an electrolyte activating one or more anodes and one or more cathodes. The electrolyte includes one or more salts and one or more additives in a solvent. The solvent includes a silane or a siloxane. The one or more additives form a passivation layer on at least one of the anodes. In some instances, the additives include vinyl carbonate (VC), and/or vinyl ethylene carbonate (VEC).

### REFERENCE TO RELATED APPLICATIONS

This application is a continuation-in-part of U.S. patent application Ser. No. 10/496,231, filed on May 20, 2004, entitled “Method for Fabricating Composite Electrodes;” which claims priority to PCT Application number PCT/US03/08783, filed on Mar. 20, 2003, entitled “Method for Fabricating Composite Electrodes;” which claims priority to U.S. Provisional Patent Application Ser. No. 60/451,065, filed on Feb. 26, 2003 and entitled “Method for Fabricating Composite Electrodes;” and to PCT Application number PCT/US03/02128, filed on Jan. 22, 2003, entitled “Solid Polymer Electrolyte and Method of Preparation;” and to U.S. patent application Ser. No. 10/167,940, filed on Jun. 12, 2002, and entitled “Nonaqueous Liquid Electrolyte;” and to U.S. patent application Ser. No. 10/104,352, filed Mar. 22, 2002, and entitled “Solid Polymer Electrolyte and Method of Preparation;” and to provisional application Ser. No. 60/443,892, filed Jan. 30, 2003, and entitled “Nonaqueous Liquid Electrolyte;” and to provisional application Ser. No. 60/446,848, filed Feb. 11, 2003, and entitled “Polymer Electrolyte for Electrochemical Cell;” and to PCT Application number PCT/US03/02127, filed on Jan. 22, 2003, entitled “Nonaqueous Liquid Electrolyte;” which claims priority to U.S. patent application Ser. No. 10/496,230, filed on May 20, 2004, entitled “Solid Polymer Electrolyte and Method of Preparation.” Each of the applications in this paragraph is incorporated herein in its entirety.

This application is also a continuation-in-part of U.S. patent application Ser. No. 10/810,019, filed on Mar. 25, 2004, and entitled “Polysiloxanes for Use in Electrochemical Cells;” and of U.S. patent application Ser. No. 10/810,081, filed on Mar. 25, 2004, and entitled “Electrolyte Including Polysiloxane with Cyclic Carbonate Groups;” which claims priority to U.S. Provisional Patent Application Ser. No. 60/502,017, filed on Sep. 10, 2003, entitled “Electrolyte Including Polysiloxane with Cyclic Carbonate Groups;” and of U.S. patent application Ser. No. 10/810,080, filed on Mar. 25, 2004, and entitled “Electrolyte for Use in Electrochemical Devices.” This application claims priority to U.S. Provisional Patent Application Ser. No. 60/542,017, filed on Feb. 4, 2004, and entitled “Nonaqueous Electrolyte Solvents for Electrochemical Devices;” and to U.S. Provisional Patent Application Ser. No. 60/543,951, filed on Feb. 11, 2004, and entitled “Siloxanes;” and to U.S. Provisional Patent Application Ser. No. 60/543,898, filed on Feb. 11, 2004, and entitled “Siloxane Based Electrolytes for Use in Electrochemical Devices; and to U.S. Provisional Patent Application Ser. No. 60/601452, filed on Aug. 13, 2004, entitled “Electrolyte Including Silane for Use in Electrochemical Devices.” Each of the applications in this paragraph is incorporated herein in its entirety.

This application is also related to U.S. Provisional Patent Application Ser. No. 60/563,850, filed on Apr. 19, 2004, entitled “Organoborate Salt in Electrochemical Device Electrolytes,” and incorporated herein in its entirety. This application is also related to U.S. Provisional Patent Application Ser. No. 60/565,211, filed on Apr. 22, 2004, entitled “Organoborate Salt in Electrochemical Device Electrolytes,” and incorporated herein in its entirety. This application is also related to U.S. Provisional Patent Application Ser. No. 60/563,848, filed on Apr. 19, 2004, entitled “Composition Check for Organoborate Salt Employed in Electrochemical Device Electrolytes,” and incorporated herein by reference in its entirety. This application is also related to U.S. Provisional Patent Application Ser. No. 60/563,849, filed on Apr. 19, 2004, entitled “Battery Employing Electrode Having Graphite Active Material,” and incorporated herein by reference in its entirety. This application is also related to U.S. Provisional Patent Application Ser. No. 60/563,852, filed on Apr. 19, 2004, entitled “Battery Having Anode Including Lithium Metal,” and incorporated herein by reference in its entirety.

### STATEMENT REGARDING FEDERALLY SPONSORED RESEARCH OR DEVELOPMENT

This invention was made with United States Government support under NIST ATP Award No. 70NANB043022 awarded by the National Institute of Standards and Technology (NIST). The United States Government has certain rights in this invention pursuant to NIST ATP Award No. 70NANB043022 and pursuant to Contract No. W-31-109-ENG-38 between the United States Government and the University of Chicago representing Argonne National Laboratory, and NIST 144 LMOI, Subcontract No. AGT DTD Sep. 9, 2002.

### FIELD

The present invention relates to electrochemical devices, and more particularly to electrochemical devices having electrolytes that include additives.

### BACKGROUND

The increased demand for lithium batteries has resulted in research and development to improve the safety and performance of these batteries. The organic carbonate solvents employed in the electrolytes of many batteries are associated with high degrees of volatility, flammability, and chemical reactivity. A variety of electrolytes that include polysiloxane solvents have been developed to address these issues. However, secondary batteries that include polysiloxane solvents have shown poor capacity and/or cycling performance when used in secondary batteries. As a result, there is a need for a battery that has the safety provided by polysiloxane solvents combined with acceptable capacity and/or cycling capabilities. SUMMARY

A battery is disclosed. The battery includes an electrolyte activating one or more anodes and one or more cathodes. The electrolyte includes one or more salts and one or more additives in a solvent. The solvent includes a silane or a siloxane. The one or more additives form a passivation layer on at least one of the anodes.

At least one of the additives can be selected from a group consisting of vinyl carbonate (VC), vinyl ethylene carbonate (VEC), ethylene sulfite (ES), propylene sulfite (PS), 1,3 dimethyl butadiene, styrene carbonate, phenyl ethylene carbonate (PhEC) an aromatic carbonate, vinyl pyrrole, vinyl piperazine, vinyl piperidine, and vinyl pyridine. In one embodiment, at least one of the additives is selected from a group consisting of vinyl carbonate (VC), vinyl ethylene carbonate (VEC), ethylene sulfite (ES), propylene sulfite (PS), and phenyl ethylene carbonate (PhEC). In another embodiment, at least one of the additives is selected from a group consisting of vinyl carbonate (VC), and vinyl ethylene carbonate (VEC). In some instances, the one or more additives are present in the electrolye in a concentration less than 20 wt %, 10 wt %, less than 5 wt %, or less than 3 wt %.

The siloxanes can include one or more silicons linked to a substituent that includes a poly(alkylene oxide) moiety or a cyclic carbonate moiety. The siloxane can be a tetrasiloxane, a trisiloxane or a disiloxanes. The silanes can include a silicon linked to one or more substituents that each include a poly(alkylene oxide) moiety or a cyclic carbonate moiety.

### BRIEF DESCRIPTION OF THE FIGURES

FIG. 1 is a schematic view of a battery.

FIG. 2 illustrates a cross section of a button cell.

FIG. 3 compares the voltage versus capacity performance for a battery having an electrolyte with VEC to a battery having an electrolyte without VEC.

FIG. 4 compares the cycling performances for a battery having an electrolyte with VEC to a battery having an electrolyte without VEC.

FIG. 5 shows the cycling performances of a battery having an electrolyte that includes a VC additive.

FIG. 6 is a plot of voltage versus capacity for button cells having different concentrations of VEC in a polysiloxane.

FIG. 7 presents a plot of discharge capacity versus cycle number for each of the button cells of FIG. 6.

### DESCRIPTION

A battery is disclosed. The battery employs an electrolyte that activates one or more anodes and one or more cathodes. The electrolyte includes an additive in a solvent that includes one or more siloxanes and/or one or more silanes. The additive forms a passivation layer on at least one anode and/or one at least one cathode. Additives such as VC and VEC have been found to increase the capacity and/or the cycling capabilities of the disclosed batteries. Without being bound to theory, VC and/or VEC are believed to form a passivation layer on an electrode that is more stable than the passivation layers formed by the solvents. The enhanced stability of the passivation layer may be sufficient to increase the capacity and/or cycling properties of batteries. Additionally or alternately, the VC and/or VEC can reduce the viscosity of the siloxanes and/or silanes in the sovent. The reduced viscosity may improve wetting of electrodes in an electrochemical device enough to enhance the homogeneity of the electrolyte distribution in the cell. The enhanced homogeneity may be sufficient to increase the capacity and cycling properties of batteries. The stabilized passivation layer or the reduced viscosity may work independently or together to enhance the capacity and cycling properties of batteries.

The solvent can include or consist of polysiloxanes but preferably includes or consists of tetrasiloxanes, trisiloxanes and/or disiloxanes. Tetrasiloxanes, trisiloxanes or disiloxanes can yield an electrolyte with a lower viscosity than electrolytes that include similarly structured polysiloxanes. The reduced viscosity can further improve wetting of electrodes in an electrochemical device enough to enhance the homogeneity of the electrolyte distribution in the cell. Surprisingly, the enhanced homogeneity can be sufficient to increase the capacity and cycling properties of batteries. For instance, when the device is repeatedly cycled between 2.7 V and 4.0 V using a charge and discharge rate of 0.2 C after formation of a passivation layer on the anode, these electrolytes may provide a secondary battery having a discharge capacity retention greater than 90% at cycle number 100.

The solvent can also include or consist of one or more silanes. Silanes can have a viscosity that is reduced relative to similarly structured polysiloxanes, tetrasiloxanes, trisiloxanes or disiloxanes. The additional reduction in viscosity can further improve wetting of electrodes in an electrochemical device enough to further increase the capacity and cycling properties of batteries. For instance, when the device is repeatedly cycled between 2.7 V and 4.0 V using a charge and discharge rate of 0.2 C after formation of a passivation layer on the anode, these electrolytes may provide a secondary battery having a discharge capacity retention greater than 90% at cycle number 100.

The tetrasiloxanes, trisiloxanes, disiloxanes and/or silanes can also provide an electrolyte with high ionic conductivities in addition to enhanced cycling properties. For instance, one or more of the silicons in the tetrasiloxanes, trisiloxanes, disiloxanes and/or silanes can each be linked to a first substituent that includes a poly(alkylene oxide) moiety. The poly(alkylene oxide) moieties can help dissolve lithium salts employed in the electrolyte. Accordingly, the tetrasiloxanes, trisiloxanes, disiloxanes and/or silanes can provide an electrolyte with a concentration of free ions suitable for use in batteries. Additionally, the poly(alkylene oxide) moieties can enhance the ionic conductivity of the electrolyte at room temperatures. For instance, these silanes can yield an electrolyte with an ionic conductivity higher than 1×10⁻⁴ S/cm at 25° C. or higher than 3×10⁻⁴ S/cm at 37° C. At these performance levels, the electrolytes can be suitable for use in batteries such as high-energy and long cycle life lithium secondary batteries, satellite applications, and biomedical devices such as defibrillators.

Additionally or alternately, one or more of the silicons in the tetrasiloxanes, trisiloxanes, disiloxanes and/or silanes can each be linked to a second substituent that includes a cyclic carbonate moiety. The cyclic carbonate moieties can have a high ability to dissolve the salts that are employed in battery electrolytes. As a result, the carbonates can provide high concentrations of free ions in the electrolyte and can accordingly increase the ionic conductivity of the electrolyte. For instance, these silanes can yield an electrolyte with an ionic conductivity higher than 1×10⁻⁴ S/cm at 25° C. or higher than 3×10⁻⁴ S/cm at 37° C.

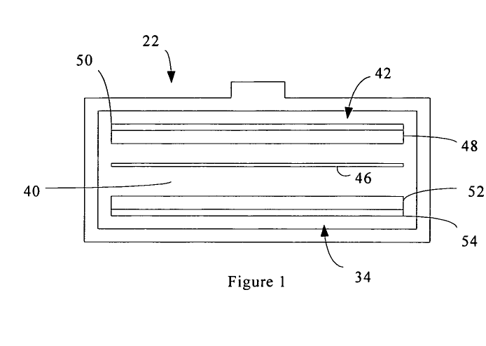

FIG. 1 is a schematic view of a suitable battery 22. The battery 22 includes an electrolyte 40 activating a cathode 42 and an anode 44. A separator 46 separates the cathode 42 and anode 44. The cathode 42 includes a cathode medium 48 on a cathode substrate 50. The anode 44 includes an anode medium 52 on an anode substrate 54. Although the battery is illustrated as including one anode and one cathode, the battery can include more than one anode and/or more than one cathode with the anodes and cathodes each separated by a separator. Additionally, the battery can have a variety of different configurations such as stacked configuration, a “jellyroll” or wound configurations. In some instances, the battery is hermetically sealed. Hermetic sealing can reduce entry of impurities into the battery. As a result, hermetic sealing can reduce active material degradation reactions due to impurities. The reduction in impurity induced lithium consumption can stabilize battery capacity.

Suitable cathode substrates 50 include, but are not limited to, aluminum, stainless steel, titanium, or nickel substrates. An example of a cathode substrate that can enhance conductivity is a carbon coated aluminum current collector. The carbon coating may be applied using any suitable process known in the art, such as by coating a paste made of carbon and a binder. The thickness of the carbon coating can be less than 15 microns, less than 10 microns, about 3 microns or less, and less than 2 microns.

The cathode medium 48 includes or consists of one or more cathode active materials. Suitable cathode active materials include, but are not limited to, LiₓVO_{y}, LiCoO₂, LiNiO₂, LiNi₁₋ₓCo_{y}MezO₂, LiMn_{0.5}Ni_{0.5}O₂, LiMn_{0.3}Co_{0.3}Ni_{0.3}O₂, LiFePO₄, LiMn₂O₄, LiFeO₂, LiMc_{0.5}Mn_{1.5}O₄, LiMn_{1.5}McO₄, vanadium oxide, carbon fluoride and mixtures thereof wherein Me is Al, Mg, Ti, B, Ga, Si, Mn, Zn, Mo, Nb, V and Ag and combinations thereof, and wherein Mc is a divalent metal such as Ni, Co, Fe, Cr, Cu, and combinations thereof. Preferred cathode materials include one or more lithium transition metal oxides selected from the group consisting of LiₓVO_{y}, LiCoO₂, LiNiO₂, LiNi₁₋ₓCo_{y}MezO₂, LiMn_{0.5}Ni_{0.5}O₂, LiMn_{0.3}Co_{0.3}Ni_{0.3}O₂, LiFePO₄, LiMn₂O₄, LiFeO₂, LiMc_{0.5}Mn_{1.5}O₄.

The cathode medium 48 can optionally include binders, conductors and/or diluents such as PVDF, graphite and acetylene black in addition to the one or more cathode active materials. Suitable binders include, but are not limited to, PVdF, powdered fluoropolymer, more preferably powdered polytetrafluoroethylene or powdered polyvinylidene fluoride present at about 1 to about 5 weight percent of the cathode active material. Suitable conductors and/or diluents include, but are not limited to, acetylene black, carbon black and/or graphite or metallic powders such as powdered nickel, aluminum, titanium and stainless steel.

A suitable material for the anode substrate 54 includes, but is not limited to, lithium metal, titanium, a titanium alloy, stainless steel, nickel, copper, tungsten, tantalum or alloys thereof.

The anode medium 52 includes or consists of one or more anode active materials and a binder. The anode medium 52 includes or consists of one or more anode active materials and a binder. The anode active material can include or consist of a metal selected from Groups IA, IIA and IIIB of the Periodic Table of the Elements. Examples of these anode active materials include lithium, sodium, potassium and their alloys and intermetallic compounds. Examples of suitable alloys include, but are not limited to, Li—Si, Li—Al, Li—B, Li—Si—B. Another example of a suitable lithium alloy is a lithium-aluminum alloy. However, increasing the amounts of aluminum present in the alloy can reduce the energy density of the cell. Examples of suitable intermetallic compounds include, but are not limited to, intermetallic compounds that include or consist of two or more components selected from the group consisting of Li, Ti, Cu, Sb, Mn, Al, Si, Pb, Sn, In, Bi, Ag, Ba, Ca, Hg, Pd, Pt, Te, Zn and La. Example of internmetallic compounds include Cu6Sn₅, Cu₂Sb, MnSb. Other suitable anode active materials include lithium titanium oxdes such as Li4Ti₅O₁₂, and silica alloys and mixtures of the above anode active materials.

Another example of a suitable anode active material can include a carbonaceous material or a carbonaceous mixture. For instance, the anode active material can include or consist of one, two, three or four components selected from the group consisting of: graphite, carbon beads, carbon fibers, and graphite flakes. Examples of an anode constructed having a carbonaceous mixture are provided in U.S. patent application Ser. No. 10/264870, filed on Oct. 3, 2002, entitled “Negative Electrode for a Nonaqueous Battery,” and incorporated herein in its entirety, which claims priority to U.S. Provisional Patent Application Ser. No. 60/406,846, filed on Aug. 29, 2002, and entitled “Negative Electrode for a Nonaqueous Battery,” and incorporated herein in its entirety.

Suitable binders for use with the anode medium include, but are not limited to, PVdF, carboxymethyl cellulose (CMC), and styrene butadiene rubber (SBR). When the anode active material includes a carbonaceous mixture, the binder of the anode medium can exclude fluorine, and can include carboxymethyl cellulose (CMC). In some instances, styrene butadiene rubber (SBR) is added to impart elasticity to the mixture.

In some instances, the anode consists of the anode medium. Accordingly, the anode medium also serves as the anode substrate. For instance, the anode can consist of an anode medium that includes or consists of lithium metal or that includes or consists of graphite.

Suitable separators 46 include, but are not limited to, polyolefins such as polyethylene. Illustrative separator materials also include fabrics woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, polytetrafluoroethylene membrane commercially available under the designation ZITEX (Chemplast Inc.), polypropylene/polyethylene membrane commercially available under the designation CELGARD (Celanese Plastic Company, Inc.), a membrane commercially available under the designation DEXIGLAS (C. H. Dexter, Div., Dexter Corp.), and a polyethylene membrane commercially available from Tonen Chemical Corp.

The electrolyte can include one or more salts in a solvent. Suitable salts for use with the electrolyte include, but are not limited to, alkali metal salts including lithium salts. Examples of lithium salts include LiClO₄, LiBF₄, LiAsF₆, LiPF₆, LiSbF₆, LiCF₃SO₃, LiC₆F₅SO₃, LiC(CF₃SO₂)₃, LiN(SO₂C₂F₅)₂, LiN(SO₂CF₃)₂ (LiTFSI), LiAlCl₄, LiGaCl₄, LiSCN, LiO₂, LiO₃SCF₃, LiO₂CCF₃, LiSO₆F, LiB(C₆H₅)₄, Li-methide, Li-imide, lithium alkyl fluorophosphates and combinations thereof. Additionally or alternately, the one or more salts can include or consist of an organoborate salts. Examples of suitable organoborate salts are disclosed in U.S. Patent Application Ser. No. 60/565,211, filed on Apr. 22, 2004, entitled “Organoborate Salt in Electrochemical Device Electrolytes” and incorporated herein in its entirety. Suitable organoborates salts include, but are not limited to, lithium bis-oxalato borate (LiBOB), and lithium difluoro oxalato borate (LiDfOB). The electrolyte can be prepared such that the total concentration of the one or more salts in the electrolytes is about 0.3 to 2.0 M, about 0.5 to 1.5 M, or about 0.7 to 1.2 M.

The solvent can include or consist of one or more polysiloxanes having a backbone with five or more silicons. One or more of the silicons can be linked to a first substituent and/or to a second substituent. The first substituent includes a poly(alkylene oxide) moiety and the second substituent includes a cyclic carbonate moiety. Suitable first substituents include side chains or cross links to other polysiloxanes. Further, each of the first substituents can be the same or different. In one example of the polysiloxane, each of the first substituents is a side chain. Suitable second substituents include side chains. Further, each of the second substituents can be the same or different. Each of the second substituents can be the same or different. In some instances, the terminal silicons in the backbone are not linked to either a first substituent or a second substituent. Each of the non-terminal silicons can be linked to at least one first substituent or to at least one second substituent. In some instances, the polysiloxane excludes second substituents. One or more of the silicons in the backbone of the polysiloxane can be linked to a cross-link to another polysiloxane. The cross-link can include a poly(alkylene oxide) moiety. Examples of suitable polysiloxanes are disclosed in U.S. patent application Ser. No. 10/810,019, filed on Mar. 25, 2004, entitled “Polysiloxane for Use in Electrochemical Cells,” and incorporated herein in its entirety.

Examples of suitable polysiloxanes have a structure according to General Formula 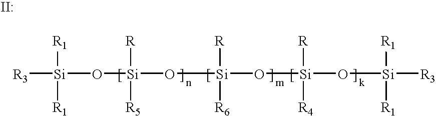
where R is alkyl or aryl; R₁ is alkyl or aryl; R₃ is represented by: 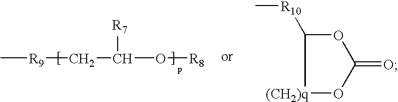
each of the R₄ is alkyl or a cross link that links the polysiloxane backbone to another polysiloxane backbone and can be the same or different; R₅ is represented by: 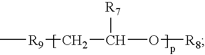
R₆ is represented by: 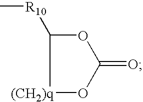
R₇ is hydrogen; alkyl or aryl; R₈ is alkyl or aryl; R₉ is oxygen or an organic spacer; R₁₀ is an oxygen or an organic spacer; k is 0 or greater than 0; p is 3, greater than 3 and/or less than 20; q is 1 to 2; m is 0 or greater than 0 and n is 0 or greater than 0 and can be 2 to 25. In some instances, n+m+k is 3 or greater than 3. In some instances, m is greater than 0 and a ratio of n:m is 1:1 to 100:1 and is more preferably 5:1 to 100:1. One or more of the alkyl and/or aryl groups can be substituted, unsubstituted, halogenated, and/or fluorinated. A suitable organic spacer can include one or more —CH₂— groups. Other suitable spacers can include an alkylene, alkylene oxide, or bivalent ether moiety. These spacers can be substituted or unsubstituted. The above spacers can be completely or partially halogenated. For instance, the above spacers can be completely or partially fluorinated. In one example, R₉ is represented by: —O—(CH₂)₃—O— or —(CH₂)₃—O— with the oxygen linked to the polyethylene oxide moiety. In another example, R₁₀ is represented by: —CH₂—O—(CH₂)₃— where the single —CH₂— group is positioned between the carbonate and the oxygen or —CH₂—O—.

In instances, where a polysiloxane according to Formula II includes one or more cross links, a suitable ratio for (number of cross links): (m+n) includes, but is not limited to, a ratio in a range of 1:4 to 1:200, in a range of 1:6 to 1: 100, or in a range of 1:6 to 1:70.

Each of the R₃ can be the same or different. In some instances, one of the R₃ includes a poly(alkylene oxide) moiety and another R₃ includes a cyclic carbonate moiety. The structures of R₃ can be the same as the structure of R₅. In some instances, the R₃ structures are different from the R₅ structures. When m is greater than 0, the structures of R₃ can be the same as the structure of R₆. In some instances, the R₃ structures are different from the structure of R. In some instances, m is 0 and R₃ and R₅ each have a structure according to 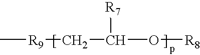
and the structures for R₃ are different from the structure for R₅ or the same as the structure for R₅.

When a polysiloxane according to General Formula I is to be employed in an electrolyte, a suitable average molecular weight for the polysiloxane includes, but is not limited to, an average molecular weight less than or equal to 3000 g/mole.

The solvent can include or consist of one or more tetrasiloxanes. Tetrasiloxanes can have a reduced viscosity relative to similarly structured tetrasiloxanes. A suitable tetrasiloxane has a backbone with two central silicons and two terminal silicons. One or more of the silicons can be linked to a first substituent and/or to a second substituent. The fist substituent includes a poly(alkylene oxide) moiety and the second substituent includes a cyclic carbonate moiety. Suitable first substituents include side chains or cross links to other tetrasiloxanes. Further, each of the first substituents can be the same or different. In one example of the tetrasiloxane, each of the first substituents is a side chain. Suitable second substituents include side chains. Further, each of the second substituents can be the same or different. Each of the second substituents can be the same or different. In some instances, the terminal silicons in the backbone are not linked to either a first substituent or a second substituent. Each of the central silicons can be linked to at least one first substituent or to at least one second substituent. In some instances, the tetrasiloxane excludes second substituents. One or more of the silicons in the backbone of the tetrasiloxane can be linked to a cross-link to another tetrasiloxane. The cross-link can include a poly(alkylene oxide) moiety. Examples of suitable tetrasiloxanes are disclosed in U.S. Provisional Patent Application Ser. No. 60/543,951, filed on Feb. 11, 2004, entitled “Siloxane,” and incorporated herein in its entirety.

An example of a suitable tetrasiloxane includes a backbone with a first silicon linked to a first side chain that includes a poly(alkylene oxide) moiety. Additionally, a second silicon in the backbone is linked to a second side chain that includes a poly(alkylene oxide) moiety or a cyclic carbonate moiety. In some instances, the first silicon and the second silicon are each terminal silicons. In other instances, the first silicon and the second silicon are each central silicons.

As the number of substituents that include a poly(alkylene oxide) moiety and/or a cyclic carbonate moiety increases, the viscosity of an electrolyte can increase undesirably and/or the ionic conductivity of an electrolyte can decrease undesirably. As a result, in some instances, the tetrasiloxane includes no more than two poly(alkylene oxide) moieties or no more than one poly(alkylene oxide) moiety. Additionally or alternately, the tetrasiloxane can include no more than two carbonate moieties or no more than one carbonate moiety. For instance, a third one of the silicons and a fourth one of the silicons can each be linked to entities that each exclude a poly(alkylene oxide) moiety and/or that each exclude a cyclic carbonate moiety. For instance, the third silicon and the fourth silicon can each be linked to substituents such as side chains that each exclude a poly(alkylene oxide) moiety and/or that each exclude a cyclic carbonate moiety. In some instances, the entities linked to the backbone of the tetrasiloxane other than the first side chain and the second side chain each exclude a poly(alkylene oxide) moiety and/or a cyclic carbonate moiety. For instance, the entities linked to the backbone of the tetrasiloxane other than the first side chain and the second side chain can each be a substituent such as a side chain and each of these substituents can exclude a poly(alkylene oxide) moiety and/or a cyclic carbonate moiety.

A silicon on the tetrasiloxane backbone can be linked directly to a poly(alkylene oxide) moiety or a spacer can be positioned between the poly(alkylene oxide) moiety and the silicon. The spacer can be an organic spacer. When the first silicon and the second silicon are each central silicons linked directly to a side chain that includes a poly(alkylene oxide) moiety, the poly(alkylene oxide) moieties each include an oxygen linked directly to the backbone. The poly(alkylene oxide) moiety can be an oligo(alkylene oxide) moiety. In some instances, the poly(alkylene oxide) moiety is a poly(ethylene oxide) moiety.

When a silicon is linked to side chains that includes a cyclic carbonate moiety, the side chain can include a spacer that links the carbonate moiety to the silicon or an oxygen can link the cyclic carbonate moiety to the silicon. The spacer can be an organic spacer.

In instances where the first silicon and the second silicons are each terminal silicons, the first and second silicons can each be linked to a side chain that includes a poly(alkylene oxide) moiety. Formula III provides an example of a tetrasiloxane where the first silicon and the second silicon are each terminal silicons linked to a side chain that includes a polyethylene oxide moiety. Formula III: 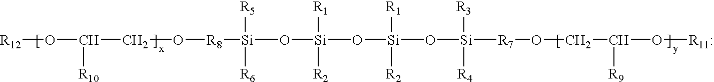
an alkyl group; R₂ is an alkyl group; R₃ is an alkyl group or an aryl group; R₄ is an alkyl group or an aryl group; R₅ is an alkyl group or an aryl group; R₆ is an alkyl group or an aryl group; R₇ is nil or a spacer; R₈ is nil or a spacer; R₉ is a hydrogen, an alkyl group or an aryl group; R₁₀ is a hydrogen, an alkyl group or an aryl group; R₁₁ is an alkyl group or an aryl group; and R₁₂ is an alkyl group or an aryl group; x is 1 or greater and/or 12 or less and y is 1 or greater and/or 12 or less. One or more of the alkyl and/or aryl groups can be substituted, unsubstituted, halogenated, and/or fluorinated. The spacers can be organic spacers and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₇ and R₈ are each nil or are each a spacer. In one example, R₇ and/or R₈ is represented by: —(CH₂)₃—. In one example: R₁; R₂; R₃; R₄; R₅; R₆; R₁₁; and R₁₂ are each methyl groups.

Examples of preferred tetrasiloxanes according to Formula III are represented by Formula III-A through Formula III-B. Formula III-A illustrates an example of a tetrasiloxane having terminal silicons linked to side chains that include an organic spacer linking a poly(alkylene oxide) moiety to a terminal silicon. Formula III-B illustrates an example of a tetrasiloxane having terminal silicons that are each linked to an oxygen included in a poly(alkylene oxide) moiety.
Formula III-A: 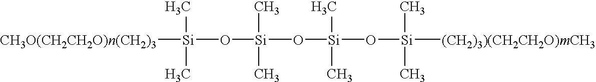
wherein n is 1 to 12 and m is 1 to 12.
Formula III-B: 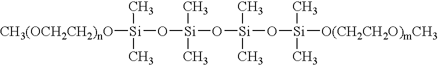
wherein n is 1 to 12 and m is 1 to 12.

Another suitable tetrasiloxane has a backbone with one of two central silicons linked to a side chain that includes a poly(alkylene oxide) moiety and the other central silicon linked to a side chain that includes a poly(alkylene oxide) moiety or a carbonate moiety. When each of the central silicons is linked to a side chain that includes a poly(alkylene oxide) moiety, the poly(alkylene oxide) moieties each include an oxygen linked directly to a silicon in the backbone.

Another example of a suitable tetrasiloxane is represented by Formula IV.
Formula IV: 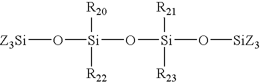
wherein: R₂₀ is an alkyl group or an aryl group; R₂₁ is an alkyl group or an aryl group; R₂₂ is represented by Formula IV-A; R₂₃ is represented by Formula IV-B or IV-C and each Z is an alkyl or an aryl group. The Zs can be the same or can be different.
Formula IV-A: 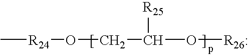
wherein R₂₄ is an organic spacer or nil; R₂₅ is hydrogen, alkyl or aryl; R₂₆ is alkyl or aryl and p is 1 or more and/or 12 or less. The organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₂₄ is represented by: —(CH₂)₃—.
Formula IV-B: 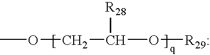
wherein R₂₈ is hydrogen, alkyl or aryl; R₂₉ is alkyl or aryl; q is 1 or more and/or 12 or less.
Formula IV-C: 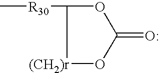
wherein R₃₀ is an organic spacer and r is 1 or 2. Suitable organic spacers for Formula IV through IV-C can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₃₀ is a bivalent ether moiety represented by: —CH₂—O—(CH₂)₃— with the —(CH₂)₃— linked to a silicon on the backbone of the tetrasiloxane. In another example, R₃₀ is an alkylene oxide moiety represented by: —CH₂—O— with the oxygen linked to a silicon on the backbone of the tetrasiloxane.

One or more of the alkyl and aryl groups specified in Formula IV through Formula IV-C can be substituted, unsubstituted, halogenated, and/or fluorinated. When R₂₃ is according to Formula IV-B, R₂₄ can be nil or can be a spacer. In one example, R₂₃ is according to Formula IV-C and R₃₀ is represented by: —CH₂—O—(CH₂)₃— where the single —CH₂— group is positioned between the carbonate and the oxygen. In an example, the Zs, R₂₀, R₂₁, R₂₆, and R₂₉ are each a methyl group. In another example, R₂₂ is represented by Formula IV-A and R₂₃ is represented by Formula IV-B and in another example R₂₃ is represented by Formula IV-A and R₂₃ is represented by Formula IV-C.

Examples of tetrasiloxanes according to Formula IV are represented by Formula IV-D through Formula IV-F. Formula IV-D represents a tetrasiloxane where each of the central silicons is linked to a side chain that includes a poly(ethylene oxide) moiety. The central silicons are each linked directly to an oxygen included in a poly(ethylene oxide) moiety. Formula IV-E and Formula IV-F each represent an example of a tetrasiloxane wherein a central silicon is linked to a side chain that includes a poly(alkylene oxide) moiety and another central silicon is linked to a side chain that includes a carbonate moiety. In Formula IV-E, an organic spacer is positioned between the poly(alkylene oxide) moiety and the silicon. In Formula IV-F, a silicon is linked directly to an oxygen included in a poly(alkylene oxide) moiety.
Formula IV-D: 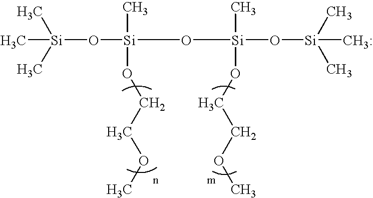
wherein n is 1 to 12.
Formula IV-E: 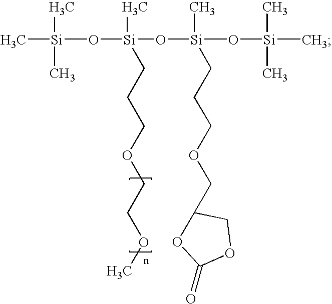
wherein n is 1 to 12.
Formula IV-F: 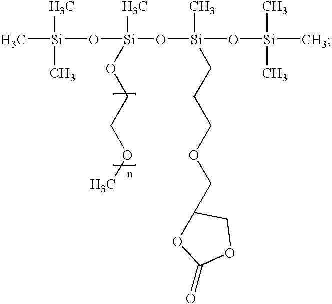
wherein n is 1 to 12.

The solvent can include or consist of one or more trisiloxanes. Trisiloxanes can have a reduced viscosity relative to similarly structured, polysiloxanes and tetrasiloxanes. A suitable trisiloxane has a backbone with three silicons. One or more of the silicons is linked to a first substituent and/or to a second substituent. The fist substituent includes a poly(alkylene oxide) moiety and the second substituent includes a cyclic carbonate moiety. Suitable first substituents include side chains or cross links to other trisiloxanes. When the trisiloxanes includes more than one first substituent, each of the first substituents can be the same or different. In one example of the polysiloxane, each of the first substituents is a side chain. Suitable second substituents include side chains. When the trisiloxanes includes more than one second substituent, each of the second substituents can be the same or different. In some instances, the terminal silicons in the backbone are not linked to either a first substituent or a second substituent. The central silicons can be linked to at least one first substituent or to at least one second substituent. In some instances, the trisiloxane excludes second substituents. One or more of the silicons in the backbone of the trisiloxane can be linked to a cross-link to another trisiloxane. The cross-link can include a poly(alkylene oxide) moiety. Examples of suitable trisiloxanes are disclosed in U.S. Provisional Patent Application Ser. No. 60/543,951, filed on Feb. 11, 2004, entitled “Siloxane,” and incorporated herein in its entirety; and U.S. Provisional Patent Application Ser. No. 60/542,017, filed on Feb. 4, 2004, entitled “Nonaqueous Electrolyte Solvents for Electrochemical Devices,” and incorporated herein in its entirety; and U.S. Provisional Patent Application Ser. No. 60/543,898, filed on Feb. 11, 2004, entitled “Siloxane Based Electrolytes for Use in Electrochemical Devices,” and incorporated herein in its entirety.

A suitable trisiloxane includes a backbone with a first terminal silicon, a central silicon and a second terminal silicon. The first terminal silicons is linked to a first side chain that includes a poly(alkylene oxide) moiety or that includes a cyclic carbonate moiety. The second terminal silicon is linked to a second side chain that includes a poly(alkylene oxide) moiety or that includes a cyclic carbonate moiety. The first side chain and the second side chain can each include a poly(alkylene oxide) moiety or can each include a cyclic carbonate moiety. Alternately, the first side can include a poly(alkylene oxide) moiety and the second side chain can include a cyclic carbonate moiety. In one example, the second side chain includes a cyclic carbonate moiety and the first side chain includes an organic spacer linking a poly(alkylene oxide) moiety to the first terminal silicon.

As the number of substituents that include a poly(alkylene oxide) moiety and/or a cyclic carbonate moiety increase, the viscosity of an electrolyte can increase undesirably and/or the ionic conductivity of an electrolyte can decrease undesirably. As a result, the trisiloxane can include no more than two poly(alkylene oxide) moieties or no more than one poly(alkylene oxide) moiety. Additionally or alternately, the trisiloxane can include no more than two carbonate moieties or no more than one carbonate moiety. For instance, each of the entities linked to the central silicon can exclude a poly(alkylene oxide) moiety and/or a cyclic carbonate moiety. Additionally or alternately, the entities linked to the first terminal silicon other than the first side chain and the entities linked to the second terminal silicon other than the second side chain can each exclude a poly(alkylene oxide) moiety and/or a cyclic carbonate moiety. In one example, each of the entities linked to the silicons in the backbone of the trisiloxane other than the first side chain and other than the second side chain exclude both a poly(alkylene oxide) moiety and a cyclic carbonate moiety. Examples of entities that may be linked to the silicons include, but are not limited to, substituents such as side chains, cross-links and halogens.

Formula V provides an example of the trisiloxane. Formula V: 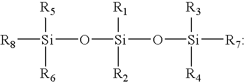
wherein R₁ is an alkyl group; R₂ is an alkyl group; R₃ is an alkyl group or an aryl group; R₄ is an alkyl group or an aryl group; R₅ is an alkyl group or an aryl group; R₆ is an alkyl group or an aryl group; R₇ is represented by Formula V-A or Formula V-B; R₈ is represented by Formula V-C or Formula V-D.
Formula V-A: 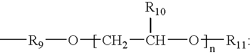
wherein R₉ is nil or a spacer; R₁₀ is hydrogen; alkyl or aryl; R₁₁ is alkyl or aryl; and n is 1 to 12. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₉ is represented by: —(CH₂)₃—.
Formula V-B: 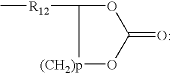
wherein R₁₂ is an organic spacer and p is 1 to 2. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₁₂ is a bivalent ether moiety represented by: —CH₂—O—(CH₂)₃— with the —(CH₂)₃— linked to a silicon on the backbone of the trisiloxane. In another example, R₁₂ is a alkylene oxide moiety represented by: —CH₂—O— with the oxygen linked to a silicon on the backbone of the trisiloxane.
Formula V-C: 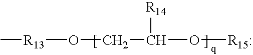
wherein R₁₃ is nil or a spacer; R₁₄ is hydrogen; alkyl or aryl; R₁₅ is alkyl or aryl; and q is 1 to 12. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₁₃ is represented by: —(CH₂)₃—.
Formula V-D: 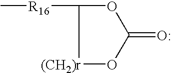
wherein R₁₆ is an organic spacer and p is 1 to 2. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₁₆ is a bivalent ether moiety represented by: —CH₂—O—(CH₂)₃— with the —(CH₂)₃— linked to a silicon on the backbone of the trisiloxane. In another example, R₁₆ is a alkylene oxide moiety represented by: —CH₂—O— with the oxygen linked to a silicon on the backbone of the trisiloxane.

One or more of the alkyl and aryl groups specified in Formula V through Formula V-D can be substituted, unsubstituted, halogenated, and/or fluorinated. In one example of a trisiloxane according to Formula V, R₇ is represented by Formula V-A with R₉ as an organic spacer and R₈ is represented by Formula V-C with R₁₃ as an organic spacer. In another example of a trisiloxane according to Formula V, R₇ is represented by Formula V-A with R₉ as nil and R₈ is represented by Formula V-C with R₁₃ as nil. In another example of a trisiloxane according to Formula V, R₇ is represented by Formula V-B and R₈ is represented by Formula V-D. In another example of a trisiloxane according to Formula V, R₇ is represented by Formula V-A with R₉ as an organic spacer and R₈ is represented by Formula V-D. In another example of a trisiloxane according to Formula V, R₇ is represented by Formula V-A with R₉ as an organic spacer and R₈ is represented by Formula V-D. In some instances, R₁, R₂, R₃, R₄, R₅, and R₆ is each a methyl group.

Formula V-E through Formula V-H are examples of trisiloxanes according to Formula V. Formula V-E and Formula V-F each illustrate a trisiloxane where each of the terminal silicons are linked to a side chain that includes a poly(ethylene oxide) moiety. Formula V-E illustrates an organic spacer positioned between each poly(ethylene oxide) moiety and the terminal silicon. Formula V-F illustrates each of the terminal silicons linked directly to a poly(ethylene oxide) moiety.
Formula V-E: 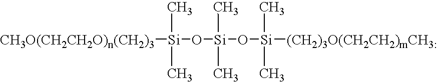
wherein n is 1 to 12 and m is 1 to 12.
Formula V-F: 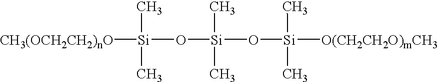
wherein n is 1 to 12 and m is 1 to 12.

Formula V-G and Formula V-H each illustrate a trisiloxane with a terminal silicon linked to a side chain that includes a cyclic carbonate moiety. Formula V-G illustrates one of the terminal silicon linked to a side chain that includes a cyclic carbonate moiety and one of the terminal silicons linked to a side chain that includes a poly(ethylene oxide) moiety. Formula V-H illustrates each of the terminal silicons linked to a side chain that includes a cyclic carbonate moiety.
Formula V-G: 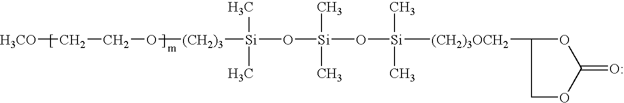
wherein m is 1 to 12.
Formula V-H:

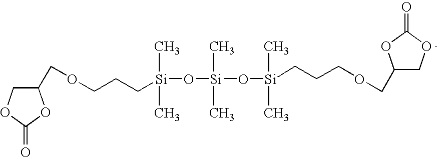

Another suitable trisiloxane includes a backbone with a first terminal silicon, a central silicon and a second terminal silicon. The central silicon is linked to a central substituent. The central substituent can be a side chain that includes a cyclic carbonate moiety, or that includes a poly(alkylene oxide) moiety linked directly to the central silicon. Alternately, the central substituent can be a cross-link that cross links the trisiloxane to a second siloxane and that includes a poly(alkylene oxide) moiety.

In some instances, the trisiloxane includes not more than two poly(alkylene oxide) moieties or not more than one poly(alkylene oxide) moiety. Additionally or alternately, the trisiloxane can include not more than two carbonate moieties or not more than one carbonate moiety. The entities linked to the first terminal silicon and the entities linked to the second terminal silicon can each exclude a poly(alkylene oxide) moiety and/or each exclude a cyclic carbonate moiety. Additionally or alternately, the entities linked to the central silicon, other than the central substituent, can exclude a poly(alkylene oxide) moiety and/or exclude a cyclic carbonate moiety. In one example, each of the entities linked to the silicons in the backbone of the trisiloxane, other than the central substituent, exclude both a poly(alkylene oxide) moiety and a cyclic carbonate moiety. Examples of entities that may be linked to the silicons include, but are not limited to, substituents such as side chains, halogens and cross-links.

An example of the trisiloxane is represented by the following Formula VI: 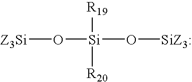
wherein R₁₉ is an alkyl group or an aryl group; R₂₀ is represented by Formula VI-A, Formula VI-B or Formula VI-C; and the Zs are each an alkyl or an aryl group and can be the same or different.
Formula VI-A: 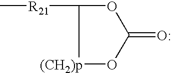
wherein R₂₁ is an organic spacer and p is 1 to 2. Suitable organic spacers can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₂, is a bivalent ether moiety represented by: —CH₂—O—(CH₂)₃— with the —(CH₂)₃— linked to a silicon on the backbone of the trisiloxane. In another example, R₂₁ is a alkylene oxide moiety represented by: —CH₂—O— with the oxygen linked to a silicon on the backbone of the trisiloxane.
Formula VI-B: 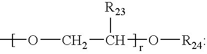
wherein R₂₃ is hydrogen; alkyl or aryl; R₂₄ is alkyl or aryl; and r is 1 to 12. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₂₂ is represented by: —(CH₂)₃—.
Formula VI-C: 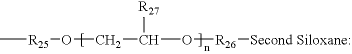
where R₂₅ is nil or a spacer; R₂₆ is nil or a spacer; R₂₇ is hydrogen, alkyl or aryl; second siloxane represents another siloxane and n is 1 to 12. When R₂₅ and/or R₂₆ is a spacer, the spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. When R₂₆ is a spacer, R₂₆ can be linked to a silicon in the backbone of the second siloxane. When R₂₆ is nil, the poly(ethylene oxide) moiety can be linked to a silicon in the backbone of the second siloxane. The second siloxane can represent another trisiloxane. When the second siloxane is a trisiloxane, R₂₆ or the poly(ethylene oxide) moiety can be linked to a central silicon in the backbone of the second trisiloxane.

One or more of the alkyl and aryl groups specified in Formula VI through Formula VI-C can be substituted, unsubstituted, halogenated, and/or fluorinated. In one example of a trisiloxane according to Formula VI, R₂₀ is represented by Formula VI-A. In another example of the trisiloxane, R₂₀ is represented by Formula VI-B. In another example, R₂₀ is represented by Formula VI-C, R₂₅ is nil, R₂₆ is nil and the poly(ethylene oxide) moiety is linked to a silicon in the backbone of the second siloxane. In another example, R₂₀ is represented by Formula VI-C, R₂₅ is a spacer, R₂₆ is a spacer linked to a silicon in the backbone of the second siloxane. In another example, R₂₅ is a spacer with the same structure as R₂₆. In another example of a trisiloxane according to Formula VI, R₁₉ and each of the Z represent methyl groups.

Formula VI-D through Formula VI-F are examples of trisiloxanes according to Formula VI. Formula VI-D illustrates a trisiloxane where the central silicon is linked to a side chain that includes a poly(ethylene oxide) moiety linked directly to the central silicon.
Formula VI-D: 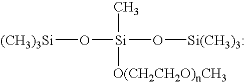
wherein n is 1 to 12.

Formula VI-E and Formula VI-F illustrate trisiloxanes having a central silicon linked to a cross link that includes a poly(ethylene oxide) moiety and that cross-links the trisiloxane to a second trisiloxane. Formula VI-E illustrates the cross link including a spacer positioned between the poly(ethylene oxide) moiety and each of the trisiloxanes. Formula VI-F illustrates a silicon in the backbone of each trisiloxane linked directly to a poly(ethylene oxide) moiety. Formula VI-E: 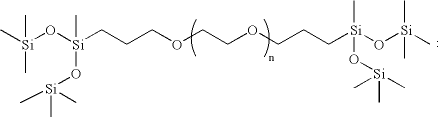
wherein n is 1 to 12. Formula VI-F: 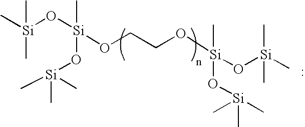
wherein n is 1 to 12.

The solvent can include or consist of one or more disiloxanes. Disloxanes can have a reduced viscosity relative to similarly structured, polysiloxanes, tetrasiloxanes and trisiloxanes. An example of a suitable disiloxane includes a backbone with a first silicon and a second silicon. The first silicon is linked to one or more first substituents that each include a poly(alkylene oxide) moiety or a cyclic carbonate moiety. The first substituent can be selected from a group consisting of a first side-chain that includes a poly(alkylene oxide) moiety, a first side-chain that includes a cyclic carbonate moiety or a cross link that includes a poly(alkylene oxide) moiety and that cross links the disiloxane to a second siloxane wherein side chains are exclusive of cross links. As the number of substituents that include a poly(alkylene oxide) moiety and/or a cyclic carbonate moiety increase, the viscosity of an electrolyte can increase undesirably and/or the ionic conductivity of an electrolyte can decrease undesirably. As a result, embodiments of the disiloxane include no more than one poly(alkylene oxide) moiety and/or no more than one cyclic carbonate moiety. For instance, the entities linked to the first silicon and the second silicon, other than the first substituent, can each exclude a poly(alkylene oxide) moiety and/or a cyclic carbonate moiety. In some instances, the disiloxane excludes a poly(alkylene oxide) moieties or excludes cyclic carbonate moieties.

The second silicon can be linked to a second substituent selected from a group consisting of a second side-chain that includes a poly(alkylene oxide) moiety, a second side-chain that includes a cyclic carbonate moiety, an aryl group or an alkyl group. In some instances, the second substituent is selected from a group consisting of a second side-chain that includes a poly(alkylene oxide) moiety and a second side-chain that includes a cyclic carbonate moiety. As noted above, the viscosity of an electrolyte can increase undesirably and/or the ionic conductivity of an electrolyte can decrease undesirably as the number of substituents that include a poly(alkylene oxide) moiety and/or a cyclic carbonate moiety increases. As a result, the disiloxanes can include no more than two poly(alkylene oxide) moiety and/or no more than two cyclic carbonate moiety. For instance, the entities linked to the first silicon and the second silicon, in addition to the first substituent and the second substituent, can each exclude a poly(alkylene oxide) moiety and/or a cyclic carbonate moiety.

Examples of suitable disiloxanes are disclosed in U.S. Provisional Patent Application Ser. No. 60/543,951, filed on Feb. 11, 2004, entitled “Siloxane,” and incorporated herein in its entirety; and U.S. Provisional Patent Application Ser. No. 60/542,017, filed on Feb. 4, 2004, entitled “Nonaqueous Electrolyte Solvents for Electrochemical Devices,” and incorporated herein in its entirety; and U.S. Provisional Patent Application Ser. No. 60/543,898, filed on Feb. 11, 2004, entitled “Siloxane Based Electrolytes for Use in Electrochemical Devices,” and incorporated herein in its entirety.

Formula VII provides an example of a suitable disiloxane. Formula VII: 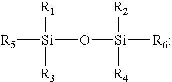
wherein R₁ is an alkyl group or an aryl group; R₂ is an alkyl group or an aryl group; R₃ is an alkyl group or an aryl group; R₄ is an alkyl group or an aryl group; R₅ is represented by Formula VII-A, Formula VII-B or Formula VII-C; R₆ is an alkyl group, an aryl group, represented by Formula VII-D, or represented by Formula VII-E.
Formula VII-A: 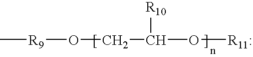
wherein R₉ is nil or a spacer; R₁₀ is hydrogen; alkyl or aryl; R₁₁ is alkyl or aryl; and n is 1 to 12. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₉ is represented by: —(CH₂)₃—.
Formula VII-B: 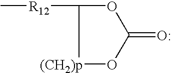
wherein R₁₂ is an organic spacer and p is 1 to 2. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₁₂ is a bivalent ether moiety represented by: —CH₂—O—(CH₂)₃— with the —(CH₂)₃— linked to a silicon on the backbone of the disiloxane. In another example, R₁₂ is a alkylene oxide moiety represented by: —CH₂—O— with the oxygen linked to a silicon on the backbone of the disiloxane.
Formula VII-C: 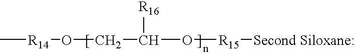
where R₁₄ is nil or a spacer; R₁₅ is nil or a spacer; R₁₆ is hydrogen, alkyl or aryl; second siloxane represents another siloxane and n is 1 to 12. The spacers can be organic spacers and can include one or more —CH₂— groups. Other suitable spacers can include an alkylene, alkylene oxide or a bivalent ether group. These spacers can be the same or different and can be substituted or unsubstituted. The above spacers can be completely or partially halogenated. For instance, the above spacers can be completely or partially fluorinated. In one example, R₁₄ and R₁₅ are each represented by: —(CH₂)₃—.
Formula VII-D: 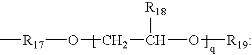
wherein R₁₇ is nil or a spacer; R₁₈ is hydrogen; alkyl or aryl; R₁₉ is alkyl or aryl; and q is 1 to 12. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₁₇ is represented by: —CH₂—O—(CH₂)₃— with the —(CH₂)₃— linked to a silicon on the backbone of the disiloxane.
Formula VII-E: 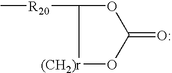
wherein R₂₀ is an organic spacer and p is 1 to 2. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₂₀ is a bivalent ether moiety represented by: —CH₂—O—(CH₂)₃— with the —(CH₂)₃— linked to a silicon on the backbone of the disiloxane. In another example, R₂₀ is a alkylene oxide moiety represented by: —CH₂—O— with the oxygen linked to a silicon on the backbone of the disiloxane.

In the disiloxanes illustrated in Formula VII: R₅ can represent Formula VII-A or Formula VII-B; or R₅ can represent Formula VII-A or Formula VII-C; or R₅ can represent Formula VII-B or Formula VII-C. Additionally or alternately: R₆ can represent an alkyl group or an aryl group or Formula VII-D; R₆ can represent an alkyl group or an aryl group or Formula VII-E. In some instances, R₁, R₂, R₃ and R₄ are each an alkyl group. For instance, R₁, R₂, R₃ and R₄ can each be a methyl group.

In one example of the disiloxane, the first substituent is a side chain that includes a poly(alkylene oxide) moiety. The poly(alkylene oxide) moiety can include an oxygen linked directly to the first silicon. For instance, the disiloxanes can be represented by Formula VII with R₅ represented by Formula VII-A and R₉ as nil. Alternately, a spacer can link the poly(alkylene oxide) moiety to the first silicon. For instance, the disiloxanes can be represented by Formula VII with R₅ represented by Formula VII-A and R₉ as a divalent organic moiety.

When the first substituent is a side chain that includes a poly(alkylene oxide) moiety, each of the entities linked to the second silicon can be alkyl groups and/or aryl groups. For instance, the second substituent can be an alkyl group or an aryl group. The disiloxanes can be represented by Formula VII with R₅ represented by Formula VII-A and R₆ as an alkyl group or an aryl group. Formula VII-F provides an example of the disiloxane. Formula VII-F: 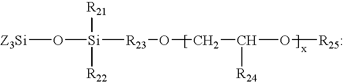
where R₂₁ is an alkyl group or an aryl group; R₂₂ is an alkyl group or an aryl group; R₂₃ is nil or a spacer; R₂₄ is a hydrogen atom or an alkyl group; R₂₅ is an alkyl group; Z is an alkyl or an aryl group and the Zs can be the same or different and x is from 1 to 30. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₂₃ has a structure according to: —(CH₂)₃—. In another example, the Zs, R₂₁, R₂₂ and R₂₅ are each a methyl group. In a preferred example, the Zs, R₂₁, R₂₂ and R₂₅ are each a methyl group, R₂₃ has a structure according to: —(CH₂)₃— and R₂₄ is a hydrogen. In a more preferred example, the Zs, R₂₁, R₂₂ and R₂₅ are each a methyl group, R₂₃ has a structure according to: —(CH₂)₃—; R₂₄ is a hydrogen; and x is 3. A preferred example of the disiloxane is provided in the following Formula VII-G: 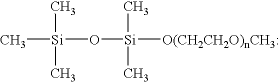
wherein n is 1 to 12. A particularly preferred disiloxane is represented by Formula VII-G with n=3.

When the first substituent is a side chain that includes a poly(alkylene oxide) moiety, the second substituent can be a side chain that includes a poly(alkylene oxide) moiety. For instance, the disiloxane can be represented by Formula VII with R₅ represented by Formula VII-A and R₆ represented by Formula VII-D. An example of the disiloxanes is provided in the following Formula VII-H: 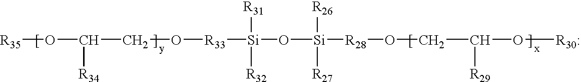
wherein R₂₆ is an alkyl group or an aryl group; R₂₇ is an alkyl group or an aryl group; R₂₈ is nil or a spacer; R₂₉ is a hydrogen atom or an alkyl group; R₃₀ is an alkyl group; R₃₁ is an alkyl group or an aryl group; R₃₂ is an alkyl group or an aryl group; R₃₃ is nil or a spacer; R₃₄ is a hydrogen atom or an alkyl group; R₃₅ is an alkyl group; x is from 1 to 30 and y is from 1 to 30. R₂₈ and R₃₃ can be the same or different. Each spacer can be an organic spacer and can include one or more —CH₂— groups. Other suitable spacers can include an alkylene, alkylene oxide or bivalent ether. These spacers can be substituted or unsubstituted. The above spacers can be completely or partially halogenated. For instance, the above spacers can be completely or partially fluorinated. In one example, R₂₈ and R₃₃ each has a structure according to: —(CH₂)₃—. In another example, R₂₆, R₂₇, R₃₁, and R₃₂ are each an alkyl group. In another example, R₂₆, R₂₇, R₃₀, R₃₁, R₃₂, and R₃₅ are each a methyl group. In another example, R₃₀ and R₃₅ have the same structure, R₂₉ and R₃₄ have the same structure, R₂₈ and R₃₃ have the same structure and R₂₆, R₂₇, R₃₁, and R₃₂ have the same structure. A preferred example of the disiloxane is presented in Formula VII-J: 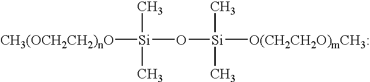
wherein n is 1 to 12 and m is 1 to 12. A particularly preferred disiloxane is represented by Formula VII-J with n=3 and m=3.

When the first substituent is a side chain that includes a poly(alkylene oxide) moiety, the second substituent can be a side chain that includes a cyclic carbonate moiety. For instance, the disiloxane can be represented by Formula VII with R₅ represented by Formula VII-A and R₆ represented by Formula VII-E.

In another example of the disiloxane, the first substituent cross links the disiloxane to a second siloxane and includes a poly(alkylene oxide) moiety. The poly(alkylene oxide) moiety can include an oxygen linked directly to the first silicon. For instance, the disiloxane can be represented by Formula VII with R₅ represented by Formula VII-C and R₁₄ as nil. In some instances, the poly(alkylene oxide) moiety also includes a second oxygen liked directly to the backbone of the second siloxane. For instance, the disiloxane can be represented by Formula VII with R₅ represented by Formula VII-C, R₁₄ as nil, and R₁₅ as nil. Alternately, a spacer can link the poly(alkylene oxide) moiety to the first silicon. For instance, the disiloxanes can be represented by Formula VII with R₅ represented by Formula VII-A and R₁₄ as a divalent organic moiety. In some instances, the poly(alkylene oxide) moiety also includes a second spacer linking the poly(alkylene oxide) moiety to the backbone of the second siloxane. For instance, the disiloxane can be represented by Formula VII with R₅ represented by Formula VII-C, R₁₄ as a divalent organic moiety, and R₁₅ as a divalent organic moiety.

When the first substituent cross links the disiloxane to a second siloxane and includes a poly(alkylene oxide) moiety, each of the entities linked to the second silicon can be an aryl group or an alkyl group. For instance, the second substituent can be an alkyl group or an aryl group. The disiloxanes can be represented by Formula VII with R₅ represented by Formula VII-C and R₆ as an alkyl group or an aryl group. Formula VII-K provides an example of the disiloxane where the poly(alkylene oxide) moiety includes an oxygen linked directly to the first silicon. Formula VII-K: 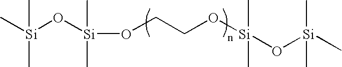
wherein n is 1 to 12. Formula VII-L provides an example of the disiloxane where an organic spacer is positioned between the poly(alkylene oxide) moiety and the first silicon. Formula VII-L: 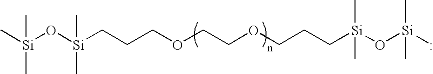
wherein n is 1 to 12.

When the first substituent cross links the disiloxane to a second siloxane and includes a poly(alkylene oxide) moiety, the second substituent can be a side chain that includes a poly(alkylene oxide) moiety. For instance, the disiloxanes can be represented by Formula VII with R₅ represented by Formula VII-C and R₆ represented by Formula VII-D.

When the first substituent cross links the disiloxane to a second siloxane and includes a poly(alkylene oxide) moiety, the second substituent can be a side chain that includes a cyclic carbonate moiety. For instance, the disiloxanes can be represented by Formula VII with R₅ represented by Formula VII-C and R₆ represented by Formula VII-E.

In another example of the disiloxane, the first substituent is a side chain that includes a cyclic carbonate moiety. For instance, the disiloxane can be represented by Formula VII with R₅ represented by Formula VII-B.

When the first substituent is a side chain that includes a cyclic carbonate moiety, each of the entities linked to the second silicon can be an aryl group or an alkyl group. For instance, the second substituent can be an alkyl group or an aryl group. The disiloxane can be represented by Formula VII with R₅ represented by Formula VII-B and with R₆ as an alkyl group or an aryl group. A preferred example of the disiloxane is presented by the following Formula VII-M:

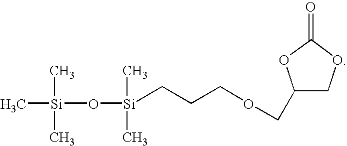

When the first substituent is a side chain that includes a cyclic carbonate moiety, the second substituent can be a side chain that includes a cyclic carbonate moiety. For instance, the disiloxane can be represented by Formula VII with R₅ represented by Formula VII-B and R₆ represented by Formula VII-E. The structure of the first substituent can be the same as the structure of the second substituent or can be different from the structure of the second substituent. A preferred example of the disiloxane is presented by the following Formula VII-N:

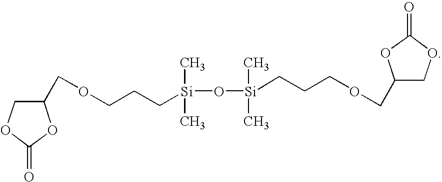

The electrolyte can include a single disiloxane and none or more other siloxanes. Alternately, the electrolyte can include two or more disiloxanes and none or more other siloxanes. Examples of other suitable siloxanes include, but are not limited to, trisiloxanes, tetrasiloxanes, pentasiloxanes, oligosiloxanes or polysiloxanes. In some instances, at least one of the two or more disiloxanes is chosen from those represented by Formula VII through Formula VII-N. Alternately, each of the disiloxanes can be chosen from those represented by Formula VII through Formula VII-N.

The solvent can include or consist of one or more silanes. An example of the silane includes a silicon linked to one or more first substituents that each include a poly(alkylene oxide) moiety or a cyclic carbonate moiety. When a first substituent includes a poly(alkylene oxide) moiety, the poly(alkylene oxide) moiety can include an oxygen linked directly to the silicon. Alternately, the first substituent can include a spacer positioned between the poly(alkylene oxide) moiety and the silicon. Suitable spacers include, but are not limited to, organic spacers. In some instances, the poly(alkylene oxide) moiety is a poly(ethylene oxide) moiety. In some instances, the poly(alkylene oxide) moiety is an oligo(alkylene oxide) moiety having from 1 to 15 alkylene oxide units. Examples of suitable silanes are disclosed in U.S. Provisional Patent Application Ser. No. 60/601452, filed on Aug. 13, 2004, entitled “Electrolyte Including Silane for Use in Electrochemical Devices,” and incorporated herein in its entirety.

The silane can include only one of the first substituents linked to a silicon or a plurality of the first substituents linked to the silicon. When the silane includes a plurality of the first substituents, the silane can include two of the first substituents, three of the first substituents or four of the first substituents. When the silane includes fewer than four first substituents, the additional substituent(s) linked to the silicon are second substituents that each exclude a poly(alkylene oxide) moiety and a cyclic carbonate moiety. Suitable second substituents include, but are not limited to, alkyl groups, aryl groups and halogens. When the silane includes a plurality of first substituents, the first substituents can each be the same or can be different. In one example, the silane includes a plurality of the first substituents and each of the first substituents is different. Alternately, the silane includes a plurality of the first substituents and a portion of the first substituents is different from another portion of the first substituents.

Examples of the first substituents include: a side-chain that includes a poly(alkylene oxide) moiety; a side-chain that includes a cyclic carbonate moiety; and a cross link that includes a poly(alkylene oxide) moiety and that cross-links the silane to a second silane where a cross link is exclusive of a side chain. Accordingly, the silane can include one or more side-chains that each include a poly(alkylene oxide) moiety and/or one or more side-chains that each include a cyclic carbonate moiety and/or one or more cross links that each include a poly(alkylene oxide) moiety and that each cross-link the silane to a second silane.

In one example, the silane includes a silicon linked to one or more side-chains that each include a poly(alkylene oxide) moiety and linked to one or more second substituents. In another example, the silane includes a silicon linked to one or more side-chains that each include a cyclic carbonate moiety and linked to one or more second substituents. In another example, the silane includes a silicon linked to one or more cross links that each include a poly(alkylene oxide) moiety and linked to one or more second substituents.

In an example, the silane includes a silicon linked to one or more side-chains that each include a poly(alkylene oxide) moiety; to one or more side-chains that each include a cyclic carbonate moiety; and to one or more second substituents. In another example, the silane includes a silicon linked to one or more side-chains that each include a cyclic carbonate moiety; to one or more cross links that each include a poly(alkylene oxide) moiety; and to one or more second substituents. In another example, the silane includes a silicon linked to one or more side-chains that each include a poly(alkylene oxide) moiety; to one or more cross links that each include a poly(alkylene oxide) moiety; and to one or more second substituents.

In one example, the silane includes a silicon linked to four side-chains that each include a poly(alkylene oxide) moiety. Accordingly, the silane can exclude cyclic carbonate moieties. In another example, the silane includes a silicon linked to four side-chains that each include a cyclic carbonate moiety. Accordingly, the silane can exclude poly(alkylene oxide) moieties. In another example, the silane includes a silicon linked to four cross links that each include a poly(alkylene oxide) moiety.

An example of the silane includes a silicon linked to one or more first substituents that each include a poly(alkylene oxide) moiety or a cyclic carbonate moiety. When a first substituent includes a poly(alkylene oxide) moiety, the poly(alkylene oxide) moiety can include an oxygen linked directly to the silicon. Alternately, the first substituent can include a spacer positioned between the poly(alkylene oxide) moiety and the silicon. Suitable spacers include, but are not limited to, organic spacers. In some instances, the poly(alkylene oxide) moiety is a poly(ethylene oxide) moiety. In some instances, the poly(alkylene oxide) moiety is an oligo(alkylene oxide) moiety having from 1 to 15 alkylene oxide units.

The silane can include only one of the first substituents linked to a silicon or a plurality of the first substituents linked to the silicon. When the silane includes a plurality of the first substituents, the silane can include two of the first substituents, three of the first substituents or four of the first substituents. When the silane includes fewer than four first substituents, the additional substituent(s) linked to the silicon are second substituents that each exclude a poly(alkylene oxide) moiety and a cyclic carbonate moiety. Suitable second substituents include, but are not limited to, alkyl groups, aryl groups and halogens. When the silane includes a plurality of first substituents, the first substituents can each be the same or can be different. In one example, the silane includes a plurality of the first substituents and each of the first substituents is different. Alternately, the silane includes a plurality of the first substituents and a portion of the first substituents is different from another portion of the first substituents.

Examples of the first substituents include: a side-chain that includes a poly(alkylene oxide) moiety; a side-chain that includes a cyclic carbonate moiety; and a cross link that includes a poly(alkylene oxide) moiety and that cross-links the silane to a second silane where a cross link is exclusive of a side chain. Accordingly, the silane can include one or more side-chains that each include a poly(alkylene oxide) moiety and/or one or more side-chains that each include a cyclic carbonate moiety and/or one or more cross links that each include a poly(alkylene oxide) moiety and that each cross-link the silane to a second silane.

In one example, the silane includes a silicon linked to one or more side-chains that each include a poly(alkylene oxide) moiety and linked to one or more second substituents. In another example, the silane includes a silicon linked to one or more side-chains that each include a cyclic carbonate moiety and linked to one or more second substituents. In another example, the silane includes a silicon linked to one or more cross links that each include a poly(alkylene oxide) moiety and linked to one or more second substituents.

In an example, the silane includes a silicon linked to one or more side-chains that each include a poly(alkylene oxide) moiety; to one or more side-chains that each include a cyclic carbonate moiety; and to one or more second substituents. In another example, the silane includes a silicon linked to one or more side-chains that each include a cyclic carbonate moiety; to one or more cross links that each include a poly(alkylene oxide) moiety; and to one or more second substituents. In another example, the silane includes a silicon linked to one or more side-chains that each include a poly(alkylene oxide) moiety; to one or more cross links that each include a poly(alkylene oxide) moiety; and to one or more second substituents.

In one example, the silane includes a silicon linked to four side-chains that each include a poly(alkylene oxide) moiety. Accordingly, the silane can exclude cyclic carbonate moieties. In another example, the silane includes a silicon linked to four side-chains that each include a cyclic carbonate moiety. Accordingly, the silane can exclude poly(alkylene oxide) moieties. In another example, the silane includes a silicon linked to four cross links that each include a poly(alkylene oxide) moiety.

A suitable silane can be represented by the following Formula VIII: SiR_{4-x-y}R′ₓR″_{y}; wherein R is a second substituent and an alkyl group, an aryl group or a halogen, R′ₓ is a first substituent that includes a poly(alkylene oxide) moiety and can be represented by Formula VIII-A or Formula VIII-C, R″_{y} is a first substituent that includes a cyclic carbonate moiety and can be represented by Formula VIII-B, x indicates the number of R′ substituents included in the silane and is 0 to 4, y indicates the number of R″ substituents included in the silane is 0 to 4, 4-x-y indicates the number of R substituents, and x+y is at least 1.
Formula VIII-A: 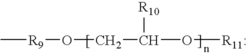
wherein R₉ is nil or an organic spacer; R₁₀ is hydrogen; alkyl or aryl; R₁₁ is alkyl or aryl; and n is 1 to 15. The spacer can be an organic spacer and can include one or more —CH₂— groups. Other suitable spacers can include an alkylene, alkylene oxide or a bivalent ether group. These spacers can be substituted or unsubstituted. In one example, R₉ is represented by: —(CH₂)₃—.
Formula VIII-B: 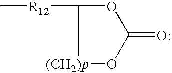
wherein R₁₂ is an organic spacer and p is 1 to 2. The spacer can be an organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₁₂ is a bivalent ether moiety represented by: —CH₂—O—(CH₂)₃— with the —(CH₂)₃— linked to a silicon on the backbone of the silane. In another example, R₁₂ is an alkylene oxide moiety represented by: —CH₂—O— with the oxygen linked to a silicon on the backbone of the silane.
Formula VIII-C: 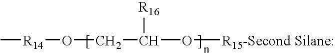
where R₁₄ is nil or a spacer; R₁₅ is nil or a spacer; R₁₆ is hydrogen, alkyl or aryl; second silane represents another silane and n is 1 to 15. The spacers can be organic spacers and can include one or more —CH₂— groups. Other suitable spacers can include an alkylene, alkylene oxide or a bivalent ether group. These spacers can be the same or different and can be substituted or unsubstituted. In one example, R₁₄ and R₁₅ are each represented by: —(CH₂)₃—. The second silane can be represented by: —SiR_{3-p-q}R′ₚR″_{q}, wherein R are each an alkyl group or an aryl group, R′ is a substituent that includes a poly(alkylene oxide) moiety and can be represented by Formula VIII-A or Formula VIII-C, R″ is a substituent that includes a cyclic carbonate moiety and can be represented by Formula VIII-B, p is the number of R′ substituents included on the second silane and is 0 to 3, q is the number of R″ substituents included on the second silane, 3-p-q is the number of R substituents, and is 0 to 3. In one example, p is 0 and q is 0. In another example, p+q is greater than or equal to 1. In yet another example, p is greater than or equal to 1. In still another example, q is greater than or equal to 1. In another example, R′ is represented by Formula VIII-A and R″ is represented by Formula VIII-B, p is 0 to 3 and q is 0 to 3.

One or more of the alkyl and aryl groups specified in Formula VIII through Formula VIII-C can be substituted, unsubstituted, halogenated, and/or fluorinated. When the silane includes more than one substituent represented by Formula VIII-A, the entities can be the same or different. When the silane includes more than one substituent represented by Formula VIII-B, the entities can be the same or different. When the silane includes more than one substituent represented by Formula VIII-C, the entities can be the same or different.

In one example of the silane according to Formula VIII, x=0. In another example, x is 1 to 3. In another example, y=0. In still another example, y is 1 to 3. In another example, x+y=4 or x +y =2.

In some instances, R′ is represented by Formula VIII-A, x is greater than 0, and R₉ is nil. In other instances, R′ is represented by Formula VIII-A and R₉ is an organic spacer. In an example, R″ is represented by Formula VIII-B and y is greater than 0. In another example, R′ is represented by Formula VIII-C, x is greater than 0, R₁₄ is nil and R₁₅ is nil. In still another example, R′ is represented by Formula VIII-C, x is greater than 0, R₁₄ is an organic spacer and R₁₅ is an organic spacer.

When the silane includes more than one substituent represented by Formula VIII-A, the entities can be the same or different. When the silane includes more than one substituent represented by Formula VIII-B, the entities can be the same or different. When the silane includes more than one substituent represented by formula VIII-C, the entities can be the same or different.

A preferred silane includes a silicon linked to one side chain that includes a poly(alkylene oxide) moiety and linked to three second substituents. For instance, the silane can be represented by Formula VIII with x=1, y=0 and the R′ represented by Formula VIII-A. Formula VIII-D presents an example of the silane that includes a silicon linked to one side chain that includes a poly(ethylene oxide) moiety, and linked to three alkyl groups. The poly(ethylene oxide) moiety of Formula VIII-D includes an oxygen liked directly to the silicon. Formula VIII-D: 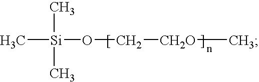
wherein n is 1 to 15. In a preferred silane according to Formula VIII-D, n=3. Formula VIII-E presents an example of the silane that includes a silicon linked to one side chain that includes a poly(alkylene oxide) moiety, and linked to three alkyl groups. The side chain of Formula VIII-E includes an organic spacer positioned between the silicon and the poly(ethylene oxide) moiety. Formula VIII-E: 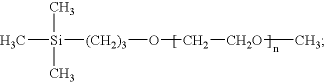
wherein n is 1 to 15. In a preferred silane according to Formula VIII-E, n=3. Formula VIII-F presents another example of the silane that includes a silicon linked to one side chain that includes a poly(alkylene oxide) moiety, and linked to three alkyl groups. The side chain of Formula VIII-F includes an organic spacer positioned between the silicon and the poly(alkylene oxide) moiety. Formula VIII-F: 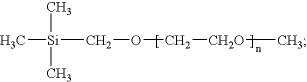
wherein n is 1 to 15. In a preferred silane according to Formula VIII-F, n=3.

A preferred silane includes a silicon linked to two side chains that each include a poly(alkylene oxide) moiety and linked to two second substitutents. For instance, the silane can be represented by Formula VIII with x=2 and y=0. One or both R′ can be represented by Formula VIII-A. One or both R′ can be represented by Formula VIII-C. In some instances, one R′ is represented by Formula VIII-A and one R′ is represented by Formula VIII-C. Formula VIII-G is an example of the silane that includes a silicon linked to two side chains that each include a poly(ethylene oxide) moiety and linked to two alkyl groups. Formula VIII-G: 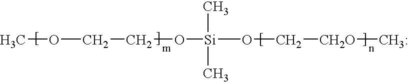
wherein m is 1 to 15, n is 1 to 15 and m can be different from n or the same as n. In a preferred silane according to Formula VIII-G, m=3 and n=3. Formula VIII-H is an example of the silane that includes a silicon linked to two side chains that each include a poly(ethylene oxide) moiety, and linked to an alkyl group, and linked to an aryl group.
Formula VIII-H: 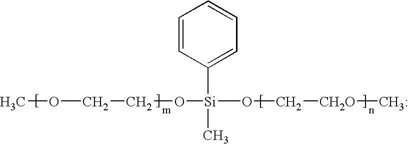
wherein m is 1 to 15, n is 1 to 15 and m can be different from n or the same as n. In a preferred silane according to Formula VIII-H, m=3 and n=3.

Another preferred silane includes a silicon linked to one side chain that includes a cyclic carbonate moiety and linked to three second substituents. For instance, the silane can be represented by Formula VIII with x=0 and y=1. Formula VIII-J is a preferred example of the silane that includes a silicon linked to a side chain that includes a cyclic carbonate moiety and linked to three alkyl groups. Formula VIII-J:

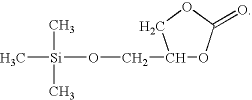

Another preferred silane includes a silicon linked to a cross link that includes a poly(alkylene oxide) moiety and linked to three second substituents. For instance, the silane can be represented by Formula VIII with x=1, y=0 and the R′ represented by Formula VIII-C. Formula VIII-K is a preferred example of the silane that includes a silicon linked to a cross link that includes a poly(alkylene oxide) moiety and linked to three alkyl groups. The poly(alkylene oxide) moiety of Formula VIII-K includes an oxygen liked directly to the silicon of each silane. Formula VIII-K: 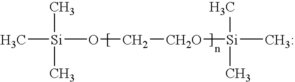
wherein n is 1 to 15. In a preferred silane according to Formula VIII-K, n =4.

The electrolyte can include a single silane. Alternately, the electrolyte can include a plurality of silanes. When the electrolyte includes a plurality of silanes, at least one of the silanes can be chosen from those represented by Formula VIII through Formula VIII-K. Alternately, each of the silanes can be chosen from those represented by Formula VIII through Formula VIII-K. In some instances, the electrolyte includes a silane that excludes poly(alkylene oxide) moieties and a silane that excludes cyclic carbonate moieties. For instance, the electrolyte can include a silane that includes one or more poly(alkylene oxide) moieties and a silane that excludes poly(alkylene oxide) moieties moieties. Alternately, the electrolyte can include a silane that includes one or more cyclic carbonate moieties and a silane that excludes cyclic carbonate moieties. In a preferred example, the electrolyte includes a blend of a silane according to Formula VIII-J and a silane according to Formula VIII-F. In another preferred example, the electrolyte includes a blend of a silane according to Formula VIII-J and a silane according to Formula VIII-D.

In some instances, the solvent includes more than one of the siloxane or more than one silane. Further, the solvent can include one or more siloxanes combined with one or more silanes. The combination of a silane with other silanes and/or with other siloxanes can reduce the viscosity of the blended solvent. Additionally, the inventors believe that the silanes can improve the mobility of poly(alkylene oxide) in other siloxanes or silanes. Additionally, the combination of a silane with other silanes and/or siloxanes can increase the ability of the solvent to dissociate the salts employed in electrolyte and can accordingly increase the concentration of free ions in the electrolyte. These features can further enhance the ionic conductivity of the electrolytes.

In some instances, the solvent includes one or more organic solvents in addition to one or more of the silanes and/or in addition to one or more of the siloxanes. Organic solvents can reduce the viscosity of the siloxanes and/or the silanes. Additionally or alternately, the addition of organic salts can increase the ionic conductivity of the electrolyte. Examples of suitable organic solvents include, but are not limited to, cyclic carbonates such as propylene carbonate (PC), ethylene carbonate (EC), butylene carbonate (BC) and vinylene carbonate (VC), linear carbonates such as dimethyl carbonate (DMC), diethyl carbonate (DEC), ethylmethyl carbonate (EMC) and dipropyl carbonate (DPC), dialkyl carbonates such as diglyme, trigylme, tetragylme, 1,2-dimethoxyethane (DME), methyl propyl carbonate, ethyl propyl carbonate, aliphatic carboxylate esters such as methyl formate, methyl acetate and ethyl propionate, gamma.-lactones such as .gamma.-butyrolactone, linear ethers such as 1,2-ethoxyethane (DEE) and ethoxymethoxyethane (EME), cyclic ethers such as tetrahydrofuran and 2-methyltetrahydrofuran, and aprotic organic solvents such as dimethylsulfoxide, 1,3-dioxolane, formamide, acetoamide, dimethylformamide, dioxolane, acetonitrile, propylnitrile, nitromethane, ethylmonoglyme, triester phosphate, timethoxymethane, dioxolane-derivatives, sulphorane, methylsulphorane, 1,3-diemthyl-2-imidazoline, 3-methyl-2-oxazolidinone, propylene carbonate-derivatives, tetrahydrofuran-derivatives, ethylether, 1,3-propanesultone, anisole, N-methylpyrrolidone and fluorinated carboxylate esters. In some instances, the solvent excludes organic solvents. When the solvent includes one or more organic solvents a suitable volume ratio of the total organic solvents to the total siloxane and silane is greater than 1:99, 1:9, or 3:7 and/or less than 9:1, 4:1 or 7:3.

The above siloxanes and silanes can be generated by employing nucleophilic substitutions, hydrosilylation and/or dehydrogenation reactions. Methods for generating the silanes and siloxanes can be found in U.S. patent application Ser. No. 10/810,019, filed on Mar. 25, 2004, entitled “Polysiloxane for Use in Electrochemical Cells;” U.S. Provisonal Patent Application Ser. No. 60/543,951, filed on Feb. 11, 2004, entitled “Siloxane;” U.S. Provisional Patent Application Ser. No. 60/542,017, filed on Feb. 4, 2004, entitled “Nonaqueous Electrolyte Solvents for Electrochemical Devices,” and incorporated herein in its entirety; and U.S. Provisional Patent Application Ser. No. 60/543,898, filed on Feb. 11, 2004, entitled “Siloxane Based Electrolytes for Use in Electrochemical Devices,” and incorporated herein in its entirety; and U.S. Provisional Patent Application Ser. No. 60/601,452, filed on Aug. 13, 2004, entitled “Electrolyte Including Silane for Use in Electrochemical Devices,” and incorporated herein in its entirety.

The electrolyte includes one or more additives that form a passivation layer on the anode. The additives can be reduced and/or polymerize at the surface of the anode to form the passivation layer. Vinyl carbonate (VC) and vinyl ethylene carbonate (VEC) are example of an additive that can form a passivation layer by being reduced and polymerizing to form a passivation layer. The result of the reduction is Li₂CO₃ and butadienne that polymerises when it sees an electron at the anode surface. Ethylene sulfite (ES) and propylene sulfite (PS) form passivation layers by mechanisms that are similar to VC. In some instances, one or more of the additives has a reduction potential that exceeds the reduction potential of the components in the solvent. For instance, VEC and VC have a reduction potential of about 2.3V. This arrangement of reduction potentials can encourage the additive to form the passivation layer before reduction of other electrolyte components and can accordingly reduce consumption of other electrolyte components.

Suitable additives include, but are not limited to, carbonates having one or more unsaturated substituents. For instance, suitable additives include unsaturated and unsubstituted cyclic carbonates such as vinyl carbonate (VC); cyclic alkylene carbonates having one or more saturated substituents such as vinyl ethylene carbonate (VEC), and CC (C₇H₄O₃); cyclic alkylene carbonates having one or more halogenated alkyl substituents such as ethylene carbonate substituted with a trifluormethyl group (trifluoropropylene carbonate, TFPC); linear carbonates having one or more unsaturated substituents such as ethyl 2-propenyl ethyl carbonate (C₂H₅CO₃C₃H₅); saturated or unsaturated halogenated cyclic alkylene carbonates such as fluoroethylene carbonate (FEC) and chloroethylene carbonate (CIEC). Other suitable additives include, acetates having one or more unsaturated substituents such as vinyl acetate (VA). Other suitable additives include cyclic alkyl sulfites and linear sulfites. For instance, suitable additives include unsubstituted cyclic alkyl sulfites such as ethylene sulfite (ES); substituted cyclic alkylene sulfites such as ethylene sulfite substituted with an alkyl group such as a methyl group (propylene sulfite, PS); linear sulfites having one or more one more alkyl substituents and dialkyl sulfites such as dimethyl sulfite (DMS) and diethyl sulfite (DES). Other suitable additives include halogenated-gamma-butyrolactones such as bromo-gamma-butyrolactone (BrGBL) and fluoro-gamma-butyrolactone (FGBL).

The additives can include or consist of one or more additives selected from the group consisting of: dimethyl sulfite (DMS), diethyl sulfite (DES), bromo-gamma-butyrolactone (BrGBL), fluoro-gamma-butyrolactone (FGBL), vinyl carbonate (VC), vinyl ethylene carbonate (VEC), ethylene sulfite (ES), CC, trifluoropropylene carbonate (TFPC), 2-propenyl ethyl carbonate, fluoroethylene carbonate (FEC), chloroethylene carbonate (ClEC), vinyl acetate (VA), propylene sulfite (PS), 1,3 dimethyl butadiene, styrene carbonate, phenyl ethylene carbonate (PhEC), aromatic carbonates, vinyl pyrrole, vinyl piperazine, vinyl piperidine, vinyl pyridine, and mixtures thereof. In another example, the electrolyte includes or consists of one or more additives selected from the group consisting of vinyl carbonate (VC), vinyl ethylene carbonate (VEC), ethylene sulfite (ES), propylene sulfite (PS), and phenyl ethylene carbonate (PhEC). In a preferred example, the electrolyte includes or consists of one or more additives selected from the group consisting of vinyl carbonate (VC), vinyl ethylene carbonate (VEC), ethylene sulfite (ES), and propylene sulfite (PS). In another preferred example, the electrolyte includes vinyl carbonate (VC) and/or vinyl ethylene carbonate (VEC).

In some conditions, certain organoborate salts, such as LiDfOB, can form a passivation layer. As a result, the desirability and/or concentration of additives may be reduced when organoborate are employed as salts. In some instances, the concentration of additives in the electrolyte generally does not greatly exceed the concentration needed to form the passivation layer. As a result, the additives are generally present in smaller concentrations than salts. A suitable concentration for an additive in the electrolyte includes, but is not limited to, concentrations greater than 0.1 wt %, greater than 0.5 wt % and/or less than 5 wt %, less than 20 wt %, or less than 35 wt % where each of the wt % refers to the percentage of the total weight of solvent plus additive. In a preferred embodiment, the concentration of the additive is less than 3 wt % or less than 2 wt %.

The electrolyte can be a liquid. In some instances, the electrolyte is a solid or a gel. For instance, the electrolyte can include a network polymer that interacts with the solvent to form an interpenetrating network. The interpenetrating network can serve as a mechanism for providing a solid electrolyte or gel electrolyte. Alternately, the electrolyte can include one or more solid polymers that are each a solid at room temperature when standing alone. The solid polymer can be employed in conjunction with the solvent to generate an electrolyte such as a plasticized electrolyte as a solid or as a gel. Alternately, one or more silanes and/or one or more siloxanes in the solvent can be cross linked to provide a solid or gel electrolyte. A polysiloxane is an example of a cross-linkable solvent. Suitable examples for method of forming a cross linked polymer are disclosed in U.S. patent application Ser. No. 10/810,019, filed on Mar. 25, 2004, entitled “Polysiloxane for Use in Electrochemical Cells” and incorporated herein in its entirety.

The battery can be a primary battery or a secondary battery. Further, the above cathode, anode and electrolyte combinations can be employed in other electrochemical devices such as capacitors and hybrid capacitors/batteries.

### EXAMPLE 1

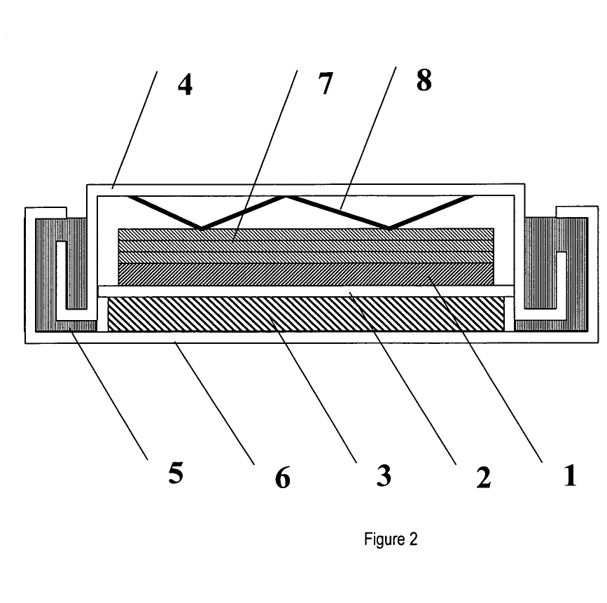

A variety of 2032 type button cells were generated having a structure according to FIG. 2. The button cells include a separator 2 positioned between a cathode 1 and an anode 3. The anode and cathode are positioned in a chamber defined by a case 4, a gasket 5 and a cover 6. A spacer 7 and a spring washer 8 are positioned between the cathode 1 and the case 4. The spacer 7 and spring washer 8 were made of stainless steel. The separator was a 25 μm thick polyethylene porous membrane (Tonen Co., Ltd.). An electrolyte activates the anode and the cathode.

The cathodes(graphite positive electrode) were generated by mixing 48 g graphite powder (Mitsui Mining Co., Ltd., GDR 3A) with 41.03 g of a 13 wt % solution of PVdF in NMP (Kureha Co., Ltd., PVdF9130) in a mixer. The result was coated onto a 10 um thickness of copper foil with a doctor blade and dried in an oven preset at 80° C. The dried result was then pressed to a 65 μm thickness. Cathodes (15 mm in diameter) were punched out of the result.

The anodes were cut from cutting 250 um thick lithium metal foil (Honjo metal Co., Ltd.).

A first electrolyte was generated by dissolving LiBOB to 0.8 M in a trisiloxane represented by 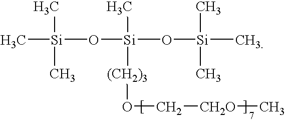
A second electrolyte was generated by dissolving LiBOB to 0.8 M in a blend of 15 wt % VEC and 85 wt % of the polysiloxane. A third electrolyte was generated by dissolving by dissolving LiBOB to 0.8 M in a blend of 15 wt % VEC and 85 wt % of the polysiloxane.

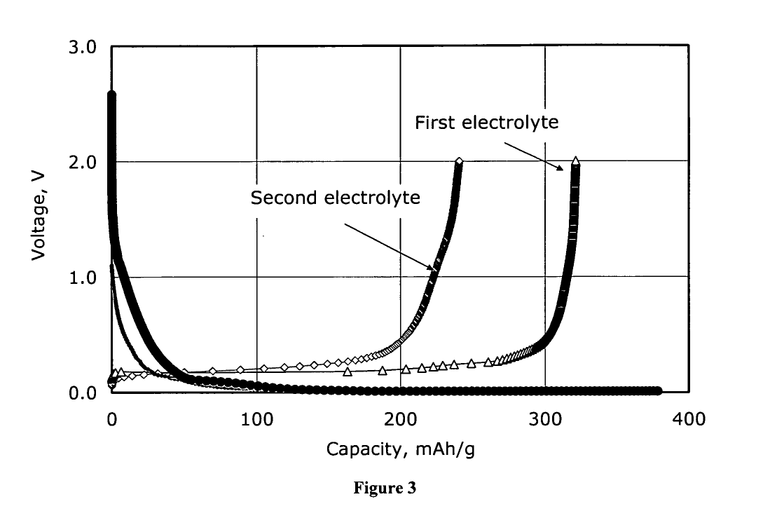

Button cells were generated with each of the electrolytes. The button cells were discharged to 0.01 V at a rate of C/20 at constant voltage at 0.01V until the current falls to C/50 and then charged to 2. o V at a rate of C/20. FIG. 3 presents the data for the batteries as a plot of voltage versus capacity. The electrolyte with the VEC shows a charge capacity of more than 300 mAh/g while the electrolyte without the VEC shows a charge capacity less than 250 mAh/g.

### EXAMPLE 2

Button cells were generated with each of the electrolytes. The button cells were repeatedly charged and discharged between 2V and 0.01 V. During formation of a passivation layer in the first two cycles, the cells were discharged (Li-intercalated) using constant current at a rate of C/20 followed by discharging at constant voltage at 0.1V until the current falls to C/50. During the same two cycles, the cells were charged (de-intercalated) at C/20. After then the cells were discharged using constant current at a rate of C/10 followed by charging at constant voltage until the current falls to C/50 and were discharged at C/10. The tests were carried out at 37° C.

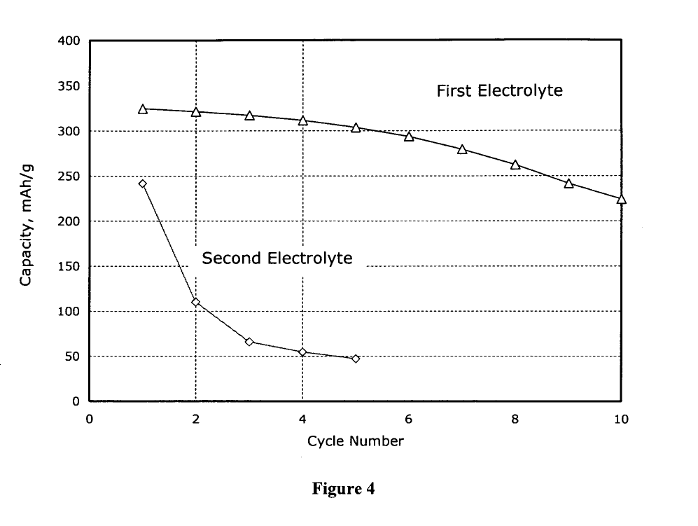

FIG. 4 presents the cycling data for each of the batteries as a plot of capacity versus cycle number. The battery having the VEC has a capacity of more than 200 mAh/g at the 9 th cycle while capacity of the battery without the VEC drops to about 50 mAh/g at about the 5 th cycle.

### EXAMPLE 3

Additional button cells were generated. Cathodes were generated by mixing 42 g LiNi_{0.8}Co_{0.15}Al_{0.05}O₂ (Toda Kogyo Co., Ltd., CA1050N) with 33.3 g of 12 wt %-solution of PVdF in n-methyl pyrolidone (NMP) (Kureha Co., Ltd., PVdF1120), 2 g acetylene black and 2 g graphite (Timcal Co., Ltd., SFG6) in a mixer. The above mixture was coated on 20 um thick of aluminum foil substrate with a doctor blade. The result was dried in an oven preset at 80° C. and pressed down to a 105 μm thickness using a roll press. Cathodes 14 mm in diameter were punched out of the result.

The anodes were generated by mixing 46.56 g Mesocarbon Microbeads (Osaka Gas Co., Ltd., MCMB 25-28) and 1.44 g vapor grown carbon fiber (Showa denko Co., Ltd. VGCF,) with 41.03 g of a 13 wt % solution of PVdF in NMP (Kureha Co., Ltd., PVdF9130) in a mixer. The result was coated onto a 10 um thickness of copper foil with a doctor blade. The result was dried in an oven preset at 80° C. The dried result was then pressed to a 65 μm thickness. Anodes (15 mm in diameter) were punched out of the result.

A disiloxane was generated with a structure according to Formula VII-J with n=3 and m=3. A fourth electrolyte was generated by dissolving LiPF₆ to 1.0 M in a blend of 2 wt % VC and 98 wt % of the disiloxane.

The button cells were generated with the electrolytes. The button cells were repeatedly charged and discharged between 2.7 V and 4.0 V. During formation of a passivation layer in the first four cycles, the cells were charged using constant current at a rate of C/20 followed by charging at constant voltage until the current falls to C/100. During the same four cycles, the cells were discharged at C/20. During the subsequent cycles, the cells were charged using constant current at a rate of C/5 followed by charging at constant voltage until the current falls to C/100 and were discharged at C/5. The tests were carried out at 37° C.

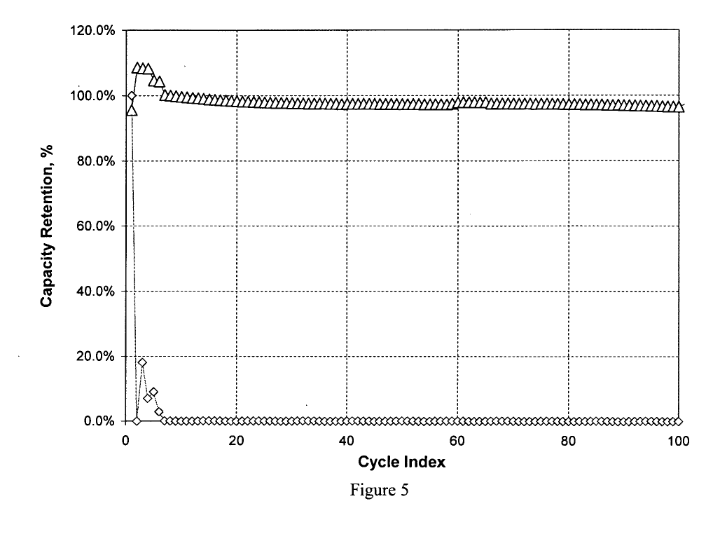

FIG. 5 presents the cycling data for each of the batteries as a plot of discharge capacity retention versus cycle number. The electrolyte having the LiPF₆ and VC has a discharge capacity retention greater than 95% at the 100 th cycle a discharge capacity retention of about 80% at the 200 th cycle in cntrast to the cell without VC which failed earlier in the testing. Accordingly, the battery can have a discharge capacity retention of more than 78% at the 200 th cycle when the battery is cycled between 2.7 V and 4.0 V after formation of a passivation layer.

### EXAMPLE 4

Additional button cells were generated. Cathodes were generated by mixing 42 g LiNi_{0.8}Co_{0.15}Al_{0.05}O₂ (Toda Kogyo Co., Ltd., CA1050N) with 33.3 g of 12 wt %-solution of PVdF in n-methyl pyrolidone (NMP) (Kureha Co., Ltd., PVdF1120), 2 g acetylene black and 2 g graphite (Timcal Co., Ltd., SFG6) in a mixer. The above mixture was coated on 20 um thick of aluminum foil substrate with a doctor blade. The result was dried in an oven preset at 80° C. and pressed down to a 105 μm thickness using a roll press. Cathodes 14 mm in diameter were punched out of the result.

The anodes were generated by mixing 46.56 g Mesocarbon Microbeads (Osaka Gas Co., Ltd., MCMB 25-28) and 1.44 g vapor grown carbon fiber (Showa denko Co., Ltd. VGCF,) with 41.03 g of a 13 wt % solution of PVdF in NMP (Kureha Co., Ltd., PVdF9130) in a mixer. The result was coated onto a 10 um thickness of copper foil with a doctor blade. The result was dried in an oven preset at 80° C. The dried result was then pressed to a 65 μm thickness. Anodes (15 mm in diameter) were punched out of the result.

A polysiloxane was generated with a structure according to Formula VII with k=0, m=0, n=8, each of the R, R₁ and R₃ as methyl, R₇ as hydrogen, R₈ as methyl, R₉ as oxygen, p=3, and represented by: 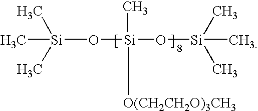
A fifth electrolyte was generated by dissolving LiTFSI to 0.8 M in a blend of 0 wt % VEC and 100 wt % of the polysiloxane. A sixth electrolyte was generated by dissolving LiTFSI to 0.8 M in a blend of 5 wt % VEC and 95 wt % of the polysiloxane. A seventh electrolyte was generated by dissolving LiTFSI to 0.8 M in a blend of 10 wt % VEC and 90 wt % of the polysiloxane. A fifth electrolyte was generated by dissolving LiTFSI to 0.8 M in a blend of 15 wt % VEC and 85 wt % of the disiloxane.

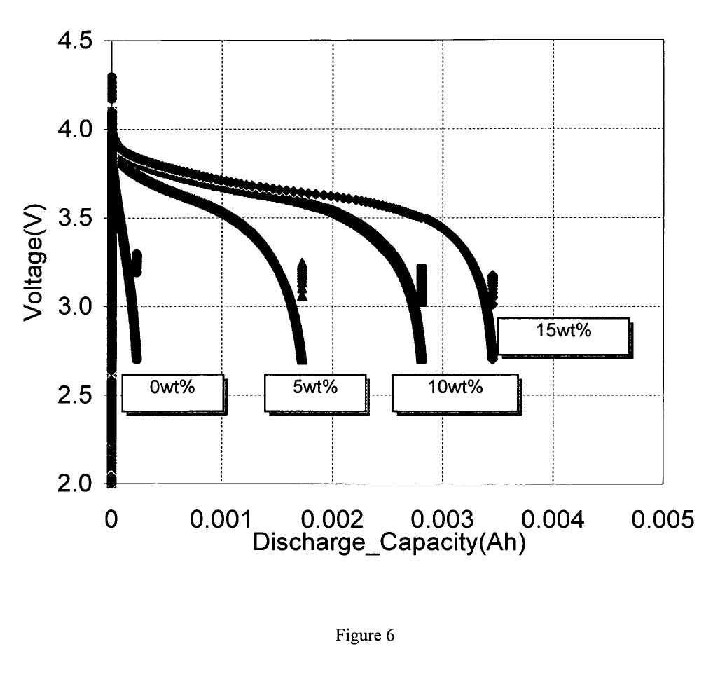

The button cells were charged to 4.1 V at a rate of C/20 until the current dropped to C/50 and then discharged at 2.7 V at a rate of C/20. FIG. 6 presents the data for each of the button cells as a plot of voltage versus capacity. The discharge capacity of the button cells increases as the additive wt % increases.

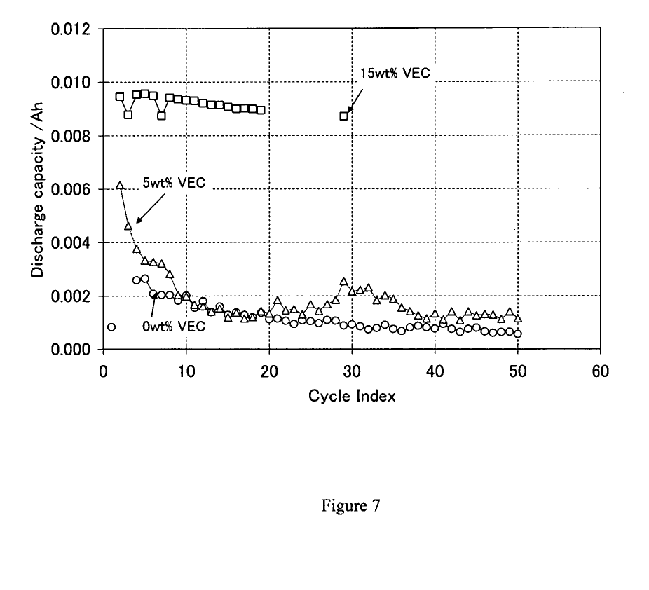

The button cells were repeatedly charged and discharged between 2.7 V and 4.1 V. During formation of a passivation layer in the first four cycles, the cells were charged using constant current at a rate of C/20 followed by charging at constant voltage until the current falls to C/100. During the same four cycles, the cells were discharged at C/20. During the subsequent cycles, the cells were charged using constant current at a rate of C/5 followed by charging at constant voltage until the current falls to C/100 and were discharged at C/5. The tests were carried out at room temperature. FIG. 7 presents a plot of discharge capacity versus cycle number for each of the button cells. Each of the button cells shows a decrease in discharge capacity with increasing cycle index. The percentage drop in discharge capacity decreases as the concentration of the VEC increase.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A battery, comprising:
an electrolyte activating one or more anodes and one or more cathodes, the electrolyte including one or more salts and one or more additives in a solvent,
the solvent including a silane or a siloxane, and
the one or more additives forming a passivation layer on at least one of the anodes.

2. The battery of claim 1, wherein one or more of the additives polymerizes at the surface of the anode so as to form the passivation layer.

3. The battery of claim 1, wherein one or more of the additives is reduced at the surface of the anode so as to form a passivation layer.

4. The battery of claim 1, wherein one or more of the additives is selected from a group consisting of vinyl carbonate (VC), vinyl ethylene carbonate (VEC), ethylene sulfite (ES), propylene sulfite (PS), 1,3 dimethyl butadiene, styrene carbonate, an aromatic carbonate, vinyl pyrrole, vinyl piperazine, vinyl piperidine, and vinyl pyridine.

5. The battery of claim 1, wherein one or more of the additives is selected from a group consisting of vinyl carbonate (VC), vinyl ethylene carbonate (VEC), ethylene sulfite (ES), propylene sulfite (PS), and phenyl ethylene carbonate (PhEC).

6. The battery of claim 1, wherein one or more of the additives is selected from a group consisting of vinyl carbonate (VC), vinyl ethylene carbonate (VEC), ethylene sulfite (ES), propylene sulfite (PS).

7. The battery of claim 1, wherein one or more of the additives is selected from a group consisting of vinyl carbonate (VC), and vinyl ethylene carbonate (VEC).

8. The battery of claim 1, wherein the one or more additives include vinyl carbonate (VC).

9. The battery of claim 1, wherein the one or more additives include vinyl ethylene carbonate (VEC).

10. The battery of claim 1, wherein at least one of the one or more salts is selected from the group consisting of: LiClO₄, LiBF₄, LiAsF₆, LiPF₆, LiSbF₆, LiCF₃SO₃, LiC₆F₅SO₃, LiC(CF₃SO₂)₃, LiN(SO₂C₂F₅)₂, LiN(SO₂CF₃)₂, LiAlCl₄, LiGaCl₄, LiSCN, LiO₂, LiO₃SCF₃, LiO₃CCF₃, LiSO₆F, LiB(C₆H₅)₄, Li-methide, Li-imide and lithium alkyl fluorophosphates.

11. The battery of claim 1, wherein at least one of the anodes includes lithium metal.

12. The battery of claim 1, wherein the electrolyte includes one or more silanes.

13. The battery of claim 12, wherein at least one silane includes a silicon linked to one or more substituents that each include a poly(alkylene oxide) moiety or a cyclic carbonate moiety.

14. The battery of claim 12, wherein at least one silane is represented by SiR_{4-x-y}R′ₓR″_{y}; wherein R is an alkyl group, an aryl group or a halogen, R′ₓ is represented by Formula VIII-A or Formula VIII-C, R″_{y} is represented by Formula VIII-B, x is 0 to 4, y is 0 to 4, 4-x-y indicates the number of R substituents, and x+y is at least 1;
Formula VIII-A: 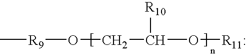
wherein R₉ is nil or an organic spacer; R₁₀ is hydrogen; alkyl or aryl; R₁₁ is alkyl or aryl; and n is 1 to 15;
Formula VIII-B: 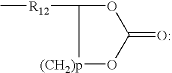
wherein R₁₂ is an organic spacer and p is 1 to 2; and
Formula VIII-C: 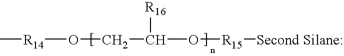
where R₁₄ is nil or a spacer; R₁₅ is nil or a spacer; R₁₆ is hydrogen, alkyl or aryl; second silane represents another silane and n is 1 to 15.

15. The battery of claim 1, wherein the electrolyte includes one or more disiloxanes.

16. The battery of claim 15, wherein at least one disiloxane includes a backbone with a silicon linked to one or more substituents that each include a poly(alkylene oxide) moiety or a cyclic carbonate moiety.

17. The battery of claim 15, wherein at least one disiloxane is represented by: 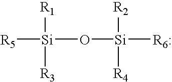
wherein R₁ is an alkyl group or an aryl group; R₂ is an alkyl group or an aryl group; R₃ is an alkyl group or an aryl group; R₄ is an alkyl group or an aryl group; R₅ is represented by Formula VII-A, Formula VII-B or Formula VII-C; R₆ is an alkyl group, an aryl group, represented by Formula VII-D, or represented by Formula VII-E;
Formula VII-A: 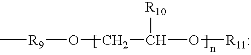
wherein R₉ is nil or a spacer; R₁₀ is hydrogen; alkyl or aryl; R₁₁ is alkyl or aryl; and n is 1 to 12;
Formula VII-B: 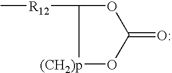
wherein R₁₂ is an organic spacer and p is 1 to 2;
Formula VII-C: 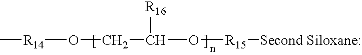
where R₁₄ is nil or a spacer; R₁₅ is nil or a spacer; R₁₆ is hydrogen, alkyl or aryl; second siloxane represents another siloxane and n is 1 to 12;
Formula VII-D: 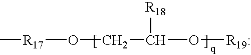
wherein R₁₇ is nil or a spacer; R₁₈ is hydrogen; alkyl or aryl; R₁₉ is alkyl or aryl; and q is 1 to 12; and
Formula VII-E: 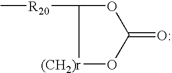
wherein R₂₀ is an organic spacer and p is 1 to 2.

18. The battery of claim 1, wherein the electrolyte includes one or more trisiloxanes.

19. The battery of claim 18, wherein at least one trisiloxane includes a backbone with three silicons, one or more of the silicons being linked to one or more substituents that each include a poly(alkylene oxide) moiety or a cyclic carbonate moiety.

20. The battery of claim 18, wherein at least one trisiloxane is represented by: 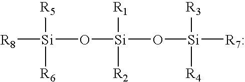
wherein R₁ is an alkyl group; R₂ is an alkyl group; R₃ is an alkyl group or an aryl group; R₄ is an alkyl group or an aryl group; R₅ is an alkyl group or an aryl group; R₆ is an alkyl group or an aryl group; R₇ is represented by Formula V-A or Formula V-B; R₈ is represented by Formula V-C or Formula V-D;
Formula V-A: 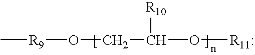
wherein R₉ is nil or a spacer; R₁₀ is hydrogen; alkyl or aryl; R₁₁ is alkyl or aryl; and n is 1 to 12;
Formula V-B: 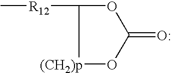
wherein R₁₂ is an organic spacer and p is 1 to 2;
Formula V-C: 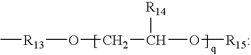
wherein R₁₃ is nil or a spacer; R₁₄ is hydrogen; alkyl or aryl; R₁₅ is alkyl or aryl; and q is 1 to 12; and
Formula V-D: 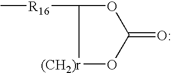
wherein R₁₆ is an organic spacer and p is 1 to 2.

21. The battery of claim 18, wherein at least one trisiloxane is represented by: 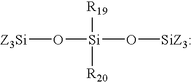
wherein R₁₉ is an alkyl group or an aryl group; R₂₀ is represented by Formula VI-A, Formula VI-B or Formula VI-C;
Formula VI-A: 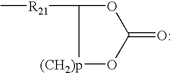
wherein R₂, is an organic spacer and p is 1 to 2;
Formula VI-B: 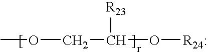
wherein R₂₃ is hydrogen; alkyl or aryl; R₂₄ is alkyl or aryl; and r is 1 to 12; and
Formula VI-C: 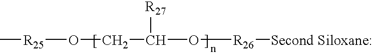
where R₂₅ is nil or a spacer; R₂₆ is nil or a spacer; R₂₇ is hydrogen, alkyl or aryl; second siloxane represents another siloxane and n is 1 to 12.

22. The battery of claim 1, wherein the electrolyte includes one or more tetrasiloxanes.

23. The battery of claim 22, wherein at least one tetrasiloxane includes a backbone with four silicons, one or more of the silicons being linked to one or more substituents that each include a poly(alkylene oxide) moiety or a cyclic carbonate moiety.

24. The battery of claim 22, wherein at least one tetrasiloxane is represented by: 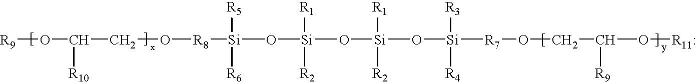
wherein R₁ is an alkyl group; R₂ is an alkyl group; R₃ is an alkyl group or an aryl group; R₄ is an alkyl group or an aryl group; R₅ is an alkyl group or an aryl group; R₆ is an alkyl group or an aryl group; R₇ is nil or an organic spacer; R₈ is nil or an organic spacer; R₉ is a hydrogen, an alkyl group or an aryl group; R₁₀ is a hydrogen, an alkyl group or an aryl group; R₁₁ is an alkyl group or an aryl group; and R₁₂ is an alkyl group or an aryl group; x is 1 or greater and/or 12 or less and y is 1 or greater and/or 12 or less.

25. The battery of claim 22, wherein at least one tetrasiloxane is represented by: 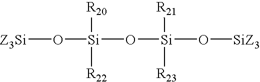
wherein: R₂₀ is an alkyl group or an aryl group; R₂₁ is an alkyl group or an aryl group; R₂₂ is represented by Formula IV-A; R₂₃ is represented by Formula IV-B or IV-C and each Z is an alkyl or an aryl group;
Formula IV-A: 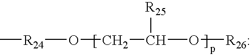
wherein R₂₄ is an organic spacer or nil; R₂₅ is hydrogen, alkyl or aryl; R₂₆ is alkyl or aryl and p is 1 or more and/or 12 or less;
Formula IV-B: 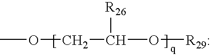
wherein R₂₈ is hydrogen, alkyl or aryl; R₂₉ is alkyl or aryl; q is 1 or more and/or 12 or less; and
Formula IV-C: 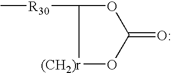
wherein R₃₀ is an organic spacer and r is 1 or 2.

26. The battery of claim 1, wherein the electrolyte includes one or more polysiloxanes.

27. The battery of claim 26, wherein at least one polysiloxane includes a backbone with five or more silicons, one or more of the silicons being linked to one or more substituents that each include a poly(alkylene oxide) moiety or a cyclic carbonate moiety.

28. The battery of claim 1, wherein at least one of the one or more anodes includes two components selected from the group consisting of: carbon beads, carbon fibers, and graphite flakes.

29. The battery of claim 1, wherein at least one of the one or more anodes includes a carbonaceous mixture that includes carbon beads, carbon fibers, and graphite flakes.

30. The battery of claim 1, wherein the one or more additives are present in the electrolyte at a concentrations less than 5 wt %.

31. The battery of claim 1, wherein the one or more additives are present in the electrolyte at a concentrations less than 3 wt %.

32. The battery of claim 1, wherein the solvent includes one or more organic solvents.

33. A method of generating a battery, comprising:
generating an electrolyte including one or more salts and one or more additives in a solvent, the solvent including a silane or a siloxane and the one or more additives being selected to form a passivation layer on an anode; and
activating one or more anodes and one or more cathodes with the electrolyte.
